(19) United States
(12) Patent Application Publication
(10) Pub. No.: US 2026/0128340 A1
(43) Pub. Date: May 7, 2026

(54) TRANSPORT PROPERTY MODULATION VIA SOLVENT SPECIFIC BEHAVIOR IN CROSSLINKED NON-AQUEOUS MEMBRANES

(71) Applicant: University of Virginia Patent Foundation, Charlottesville, VA (US)

(72) Inventors: Gary M. Koenig, Jr., Fisherville, VA (US); Geoffrey M. Geise, Charlottesville, VA (US); Patrick M. McCormack, Orchard Park, NY (US)

(21) Appl. No.: 19/117,715

(22) PCT Filed: Oct. 14, 2023
(86) PCT No.: PCT/US2023/076926

§ 371 Date: Apr. 2, 2025

Related U.S. Application Data
(60) Provisional application No. 63/416,409, filed on Oct. 14, 2022.

(51) Int. Cl. H01M 8/1025; C08J 3/24; C08J 5/22; H01M 8/18

(52) U.S. Cl. CPC H01M 8/1025; C08J 3/24; C08J 5/2287; H01M 8/188; C08J 2371/12; C08J 2471/12; H01M 2300/0037

(57) ABSTRACT

Nonaqueous redox flow batteries are one economically promising solution for meeting grid-scale energy storage needs at discharge durations of 10 h or more. However, membrane transport properties in nonaqueous systems are not as well understood as in water. Solvent-specific effects complicate efforts to understand transport in nonaqueous. In one aspect, the disclosure relates to blended cross-linked membranes compositions, methods of making same, and devices, products, and systems comprising same. In one aspect, the disclosed blended cross-linked membranes compositions comprise a cross-linked first polymer and a second polymer. The disclosed blends have desired permeabilities for selected cations and rejected undesired materials from the redox reaction mixture. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/416,409, filed on Oct. 14, 2022, which is incorporated herein by reference in its entirety.

### STATEMENT OF GOVERNMENT INTEREST

This invention was made with government support 1940915 awarded by the National Science Foundation and DE-SC0022477 awarded by the Department of Energy. The government has certain rights in the invention.

### BACKGROUND

The growing use of renewable, but nondispatchable, power sources like wind and solar has created a need for grid-scale energy storage with long discharge times (e.g., 10+ h) that currently are not common in grid-connected batteries. Redox flow batteries (RFBs) have been proposed as an option for grid-scale energy storage, but one limitation for current aqueous electrolyte-based RFBs is relatively low volumetric energy density, which results from the electrochemical stability window of water and active material solubility. Electrolytes prepared using organic solvents have a wider electrochemical stability window than aqueous electrolytes, and the chemistry of many organic redox active materials can be modified to enable very high solubility in organic solvents and higher energy density. While many parts of the RFB have an impact on the overall efficiency and power density of the battery, the separators in nonaqueous RFBs are a limiting factor because of the lack of purpose-engineered materials for this application. The separator must offer high ionic conductivity to provide high power density and voltage efficiency, and it must have low permeability of the dissolved active materials to prevent crossover that compromises battery longevity and/or coulombic efficiency.

The properties of polymer ion exchange membrane (IEM) separators used with aqueous electrolytes have been extensively studied, but solvent-specific effects unique to nonaqueous systems are not yet fully understood. Changes in solvent can profoundly impact the solvent uptake of the polymer. For example, many membranes, which are dimensionally stable in water, may swell excessively or dissolve upon exposure to organic solvents. Even membranes that do not swell excessively can be subject to solvent-specific effects, which can lead to conductivity values much lower than expected based on solvent uptake and pure solution conductivity properties.

Despite advances in RFB membrane research, there is still a scarcity of membrane materials that offer high ionic conductivity to provide high power density and voltage efficiency, that have low permeability of dissolved active materials to prevent crossover that can compromise battery longevity and/or coulombic efficiency. An ideal RFB membrane would allow ion selective flow while retaining non-desired ions, reactants, and other products from redox reactions and would function in an organic, non-aqueous liquid. These needs and other needs are satisfied by the present disclosure.

### SUMMARY

In accordance with the purpose(s) of the disclosure, as embodied and broadly described herein, the disclosure, in one aspect, relates to blended cross-linked membranes compositions, methods of making same, and devices, products, and systems comprising same.

Disclosed are cross-linked blended membrane compositions comprising: a blend of a first polymer and a second polymer, wherein the first polymer is a cross-linked polymer; and wherein the first polymer has a structure represented by a formula:

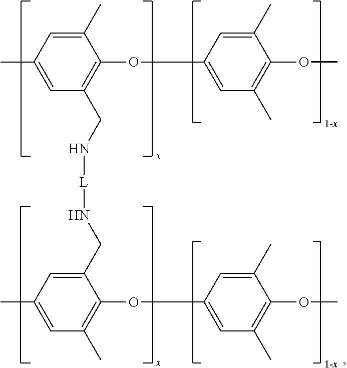

wherein x has a value from about 0.2 to about 0.9; and wherein L is a structure represented by a formula selected from:

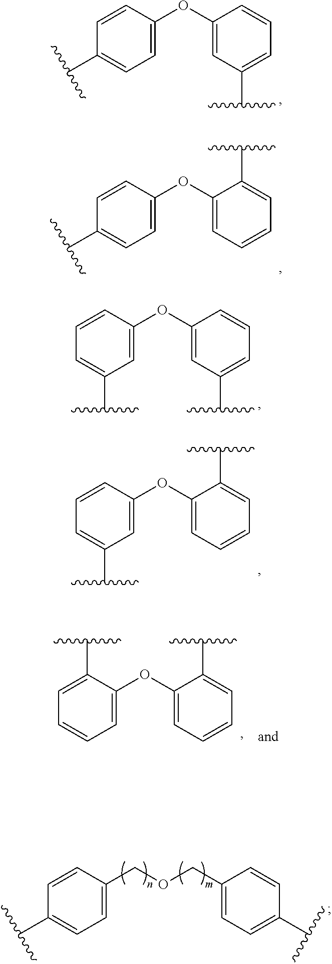

wherein each of n and m is an integer independently selected from 0, 1, 2, and 3; wherein the second polymer has a structure represented by a formula:

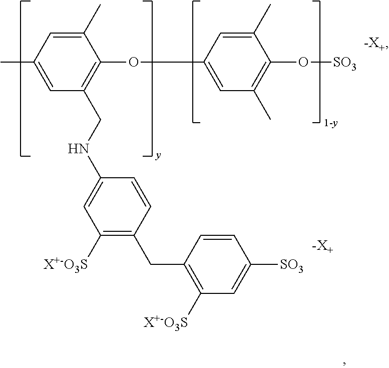

wherein y has a value from about 0.02 to about 0.6; and wherein X⁺ is a cation selected from H⁺, an alkali metal cation, and combinations thereof.

Also disclosed are methods of making blended cross-linked membrane compositions, forming a pre-crosslinking mixture comprising a first polymer and a second polymer, wherein the first polymer has a structure represented by a formula:

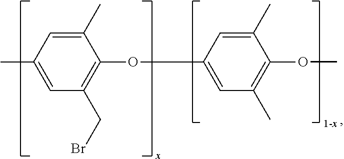

wherein x has a value from about 0.2 to about 0.9; wherein the second polymer has a structure represented by a formula:

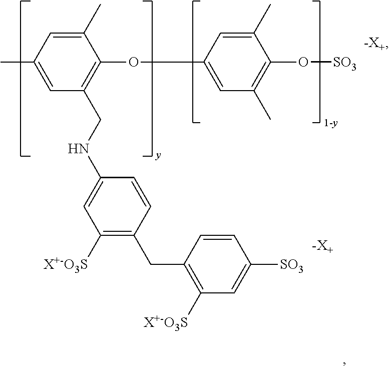

wherein y has a value from about 0.02 to about 0.6; and wherein X⁺ is a cation selected from H⁺, an alkali metal cation, and combinations thereof; forming a pre-crosslinked membrane from the pre-crosslinking mixture; drying the uncrosslinked membrane; pre-swelling the pre-crosslinked membrane with a swelling solution comprising a cross-linker and a first organic solvent, thereby forming a swollen pre-crosslinked membrane; and wherein the cross-linker is a structure represented by a formula selected from:

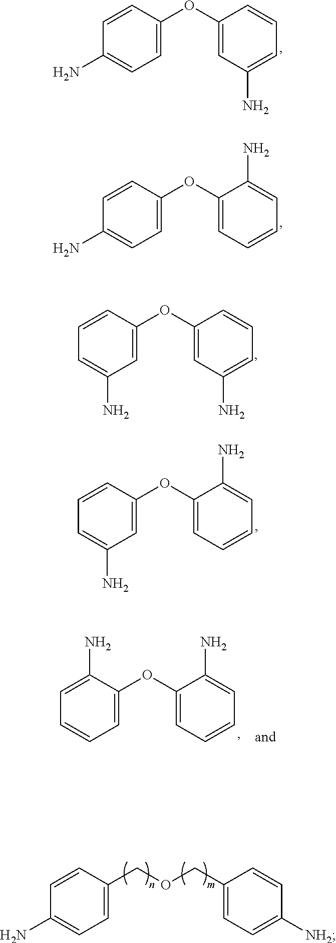

wherein each of n and m is an integer independently selected from 0, 1, 2, and 3; initiating a cross-linking reaction in the swollen pre-crosslinked membrane by adding an initiator in a second organic solvent thereto, thereby forming the cross-linked blended membrane composition; wherein the cross-linked blended membrane composition comprises the second polymer and a cross-linked polymer formed from reaction of the crosslinker; wherein the cross-linked polymer has a structure represented by a formula:

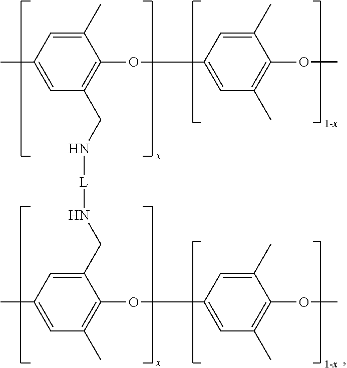

wherein L is a structure represented by a formula selected from:

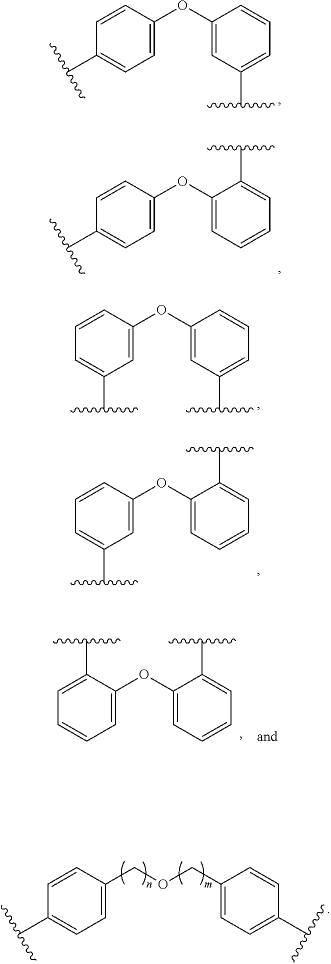

Also disclosed are blended cross-linked membrane compositions made using the disclosed methods.

Also disclosed are batteries, fuel cells, or separation devices comprising the disclosed cross-linked blended membrane compositions.

Also disclosed are redox flow battery comprising a disclosed cross-linked blended membrane composition; a positive electrode; a positive electrolyte comprising a first redox active composition, wherein the positive electrolyte is in contact with the positive electrode; a negative electrode; and a negative electrolyte comprising a second redox active composition, wherein the negative electrode is in contact with the negative electrode, and wherein the cross-linked blended membrane composition is interposed between the positive electrode and the negative electrode.

Also disclosed are energy storage systems comprising a disclosed redox flow battery, or a stack comprising a plurality thereof.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a scheme for crosslinking of brominated poly(phenylene oxide) (Br-PPO) using oxydianiline (ODA) according to one embodiment of the present disclosure.

FIGS. 2A-2B show measurement solvent uptake, expressed as the (FIG. 2A) mass of measurement solvent sorbed as a percentage of the dry polymer mass and (FIG. 2B) measurement solvent volume fraction in the swollen polymer. Measurement solvent uptakes of propylene carbonate, dimethyl carbonate, and acetonitrile are reported as a function of the de-swelling solvent used in the crosslinking procedure. The reported values are the average of values measured using three different membrane samples, and the reported uncertainty is the standard deviation of the average of each set of three membranes.

FIG. 3A shows membrane conductivity and FIG. 3B shows membrane conductivity as a percentage of the bulk electrolyte solution conductivity as a function of measurement solvent volume fraction. The membrane conductivity values were measured using crosslinked membranes immersed in 1.0 M LiFSI in either propylene carbonate, dimethyl carbonate, or acetonitrile. All reported values of membrane conductivity and solvent volume fraction are the average of the values measured using three different membrane samples, and the reported uncertainty is the standard deviation of average for each membrane set.

FIG. 4 shows ferrocene (left) and 4-hydroxy-TEMPO (right) permeability of crosslinked membranes made with different de-swelling solvents, immersed in measurement solvents: propylene carbonate, dimethyl carbonate, and acetonitrile. The permeability of 4-hydroxy-TEMPO in the ACN/PC membrane, represented by on the plot, was below the detection limit of 10⁻¹¹ cm² s⁻¹. All reported values are the average of the values measured using three different membrane samples, and the reported uncertainty is the standard deviation of each membrane set.

FIG. 5A shows permeability of ferrocene and FIG. 6B shows permeability of 4-hydroxy-TEMPO reported as a function of inverse solvent volume fraction for electrolytes prepared using different measurement solvents: propylene carbonate, dimethyl carbonate, and acetonitrile. Best fit lines are fixed to the diffusion coefficients of the molecules in bulk solution at inverse solvent volume fraction equal to 1. The permeability of 4-hydroxy-TEMPO in the ACN/PC membrane was below the detection limit and is reported as an upper bound of 10⁻¹¹ cm² s⁻¹. All reported values are the average of the values measured using three different membrane samples, and the reported uncertainty is the standard deviation of each membrane set.

FIGS. 6A-6G show photographs of membranes (FIG. 6A) after casting TEA⁺ counter-ion form polymer, (FIG. 6B) dried after conversion to the Li⁺ counter-ion form, (FIG. 6C) swollen in THF after crosslinking, after de-swelling in (FIG. 6D) water, (FIG. 6E) ethanol, and (FIG. 6F) acetonitrile, and (FIG. 6G) after exchange to propylene carbonate (left to right: water, ethanol, or acetonitrile de-swelling solvents).

FIG. 7 shows membranes after de-swelling with water and drying. The membrane on the left was crosslinked by adding NaH, and the membrane on the right was prepared without NaH, i.e., the material on the right was not crosslinked. When no NaH was added, the non-crosslinked membranes were very fragile and difficult to handle while highly swollen with THF (weight uptake ˜150%). These materials fell apart during the de-swelling step with water (right). The non-crosslinked membranes also shriveled up after drying to a greater extent compared to what was observed for the crosslinked membranes.

FIGS. 8A-8B show 1H-NMR spectra of Br-PPO-16.6 (FIG. 8A) and Br-PPO-79 (FIG. 8B), both taken in CDCl₃. Integrated peak at approximately 2.1 ppm represents the aromatic —CH₃ group of the PPO, and the integrated peak at approximately 4.3 represents the substituted —CH₂Br group.

FIG. 9 shows example electrochemical impedance spectroscopy Nyquist plot used to determine ionic conductivity. The specific membrane for the collected data was obtained using a membrane de-swelled in ethanol and measured using 1M LiFSI in acetonitrile.

FIGS. 10A-10B show absorbance vs. concentration calibration curves for (FIG. 10A) ferrocene (peak at 442 nm) and (FIG. 10B) 4-hydroxy-TEMPO (peak at 330 nm). These representative calibration curves were prepared using DMC as the solvent. Line through data points in both plots is linear regression line of best fit.

FIG. 11 shows measured area specific resistance (ASR) of membranes as a function of measurement solvent volume fraction. The membrane resistances were measured using crosslinked membranes immersed in 1.0 M LiFSI in either propylene carbonate, dimethyl carbonate, or acetonitrile. All reported values of membrane ASR and solvent volume fraction were the average of three trials, and reported uncertainty was the standard deviation of these three measurements.

FIG. 12 shows fixed charge concentrations of membranes soaked in propylene carbonate, dimethyl carbonate, and acetonitrile measurement solvents as a function of the de-swelling solvent used in the crosslinking procedure. All reported values were the average of three trials, and reported uncertainty was the standard deviation of the three measurements.

FIG. 13 shows membrane ionic conductivity as a function of IEC. IEC was calculated based on the NMR measured degree of bromination of the precursor Br-PPO. Data for non-crosslinked polymers is from the literature.

FIG. 14 shows membrane lithium-ion conductivity as a function of IEC, calculated based on the NMR measured degree of bromination of the precursor Br-PPO.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Non-aqueous redox flow batteries can operate at a higher voltage and energy density than aqueous systems. The further development of these batteries can benefit from membrane separators engineered more particularly for non-aqueous applications. According to one aspect of the presently disclosed subject matter is the preparation and characterization of a series of membranes engineered for a nonaqueous redox flow battery by functionalizing a poly(phenylene oxide) (PPO) backbone with increasing amounts of a sulfonated side chain, phenoxyaniline trisulfonate (POATS). These POATS-PPO membranes can be crosslinked and appear to be dimensionally stable over a period of time in non-aqueous electrolyte and can exhibit lithium ion conductivities greater than that of previously reported control membranes.

Studies have investigated potential redox couples for non-aqueous RFBs, but less attention has been given to the membrane separator that is required in these batteries. During battery operation, a charge carrier is transported from one half of the battery to the other to balance the movement of electrons in the battery. To prevent self-discharge and a permanent loss of battery capacity, the ideal membrane provides select transport of these charge carriers while simultaneously preventing the transport (or crossover) of the redox active molecule(s).

Most studies on non-aqueous RFB test cells have used either nanoporous, microporous, or ion-exchange membrane (IEM) separators. Nanoporous and microporous separators provide favorable ionic conductivity but can do little to prevent crossover, particularly for some active species. IEMs can provide better crossover resistance but often provide lower conductivity than their nanoporous counterparts, resulting in a high internal resistance and low energy efficiency. Some currently used IEMs include perfluorinated cation exchange membranes based on tetrafluoroethylene-fluorovinylether copolymers with acid functions, such as those sold under the tradename NAFION® (Chemours Company, Wilmington, Delaware, United States of America) and an anion exchange membrane sold under the tradename NEOSPETA™ AHA (Tokuyama Corporation, Shunan, Japan). However, both of these membranes were designed for use in aqueous systems, which can lead to suboptimal performance in non-aqueous systems. For instance, non-aqueous solvents can interact more favorably with polymers compared to water, causing some polymeric membranes to swell excessively in non-aqueous electrolytes. Also, little is known about how the difference in solvent interactions affect ion transport properties. Other options include porous separators, which can exhibit high crossover unless a solid suspension of active materials are used, or ceramic membranes, which are brittle and can sometimes react with the redox active molecule.

To improve the performance of non-aqueous flow batteries, the presently disclosed subject matter provides, in one aspect, an IEM that combines high conductivity and low crossover in non-aqueous electrolytes. For example, the presently disclosed IEM provides increased conductivity compared to previously reported IEMs.

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. DEFINITIONS

As used herein, a “redox flow battery” or “RFB” is a type of electrochemical cell that stores electrical energy as chemical energy through oxidation and reduction of redox active components in an electrolyte. In an aspect, the energy storage capacity of an RFB can be reduced or enlarged through size adjustment of external electrolyte storage tanks. In one aspect, in an RFB, electrolyte is stored outside the electrochemical cell in external electrolyte storage tanks and flowed (e.g., pumped through) a battery cell having electrodes on separate sides of an ion exchange membrane (IEM) to generate energy.

An “ion exchange membrane” or “IEM” as used herein is a membrane having high ion selectivity. In one aspect, an IEM has high ion selectively, allowing for fast transport of a charge carrier (e.g., a lithium or sodium cation) through the membrane, while inhibiting transport of the redox active components (e.g., to prevent self-discharge of an RFB of which it is a component).

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a first polymer,” “a negative electrolyte,” or “a metallocene,” includes, but is not limited to, mixtures or combinations of two or more such first polymers, negative electrolytes, or metallocenes, and the like.

Reference to “a/an” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” metallocene is interpreted to include one or more molecules of the metallocene, where the metallocene molecules may or may not be identical (e.g., different metal centers and/or different organic ligands as may be found in a plurality of metallocenes).

As used herein, a “monomer” refers to a molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units (which can be referred to as “constitutional units” or “monomeric units”) derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

A “polymer” refers to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units.

A “chain” refers to the whole or part of a macromolecule or an oligomer comprising a linear or branched sequence of constitutional units between two boundary constitutional units, wherein the two boundary constitutional units can comprise an end group, a branch point, or combinations thereof.

A “main chain” or “backbone” refers to a linear chain from which all other chains are regarded as being pendant.

An “end group” refers to a constitutional unit that comprises the extremity of a macromolecule or oligomer and, by definition, is attached to only one constitutional unit of a macromolecule or oligomer.

The term “side chain” can refer to a group (i.e., a monomeric, oligomeric or polymeric group) that is attached to a monomeric unit of a main chain.

As used herein the terms “polyelectrolyte” and “ion conducting polymer” refer to a polymer in which a portion of the constitutional units comprise or are attached to a group having an ionizable or ionic group(s), or both.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “contacting” as used herein refers to bringing a disclosed analyte, compound, chemical, or material in proximity to another disclosed analyte, compound, chemical, or material as indicated by the context. For example, a positive electrolyte contacting a positive electrode refers to the electrolyte being in proximity to the electrode by the electrolyte interacting and binding to the electrode via ionic, dipolar and/or van der Waals interactions. In some instances, contacting can comprise both physical and chemical interactions between the indicated components. It is to be understood that chemical interactions can comprise a combination of covalent and non-covalent interactions, including one or more of ionic, dipolar, van der Waals interactions, and the like.

As used herein, the term “effective amount” refers to an amount that is sufficient to achieve the desired modification of a physical property of the composition or material. For example, an “effective amount” of a cross-linking agent refers to an amount that is sufficient to achieve the desired improvement in the property modulated by the formulation component, e.g. achieving the desired mechanical properties during normal operation. The specific level in terms of wt % in a composition required as an effective amount will depend upon a variety of factors including the amount and type of polymer to be crosslinked, amount and type of electrolytes contacting a membrane formed from the polymer, amount and type of solvent in which the electrolytes are dispersed, and end use of the article made using a membrane formed from the polymer.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

Abbreviations: RFB refers to redox flow battery; IEM refers to ion exchange membrane; PPO refers to poly(phenylene oxide); Br-PPO refers to brominated PPO, ODA refers to oxydianiline, CAN refers to acetonitrile; PC refers to propylene carbonate, TEA refers to triethylamine; DMC refers to dimethyl carbonate; ASR refers to area specific resistance; IEC refers to ion exchange capacity; NMR refers to nuclear magnetic resonance; POATS refers to phenoxyaniline trisulfonate-substituted; THF refers to tetrahydrofuran; AIBN refers to azobisisobutyronitrile; NBS refers to N-bromosuccinimide; DMF refers to dimethylformamide; EIS refers to electrochemical impedance spectroscopy; CESH refers to controlled environment sample holder; MD refers to molecular dynamics; and UV/Vis refers to ultraviolet/visible.

### B. CROSS-LINKED BLENDED MEMBRANE COMPOSITION

In one aspect, the present disclosure relates to dense polymer ion exchange membranes (IEMs). In a further aspect, these IEMs rely on connected pathways of charged regions to provide ionic conductivity. In still another aspect, the disclosed membranes can restrict small-molecule transport based on kinetic (e.g., size) or thermodynamic (e.g., charge exclusion and/or secondary interactions) factors.

In an aspect, the disclosed membranes allow ion selective flow of a desired ion while retaining non-desired ions such as, for example, non-target cations, as well as reactants and other products from the redox reaction generating the ions.

In one aspect, many membranes that are dimensionally stable in water can swell excessively or dissolve upon exposure to organic solvents. In a further aspect, even membranes that do not swell excessively can be subject to solvent-specific effects, which can lead to conductivity values much lower than expected based on solvent uptake and pure solution conductivity properties. Disclosed herein are membranes that are materially and dimensionally stable in organic solvents. In some aspects, previous membranes were brittle when functionalized and immersed in organic solvents. In a further aspect, it has advantageously been discovered that the polymers disclosed herein, when crosslinked, have desirable physical and mechanical properties in situ in organic solvents.

In an aspect, disclosed herein are sulfonated poly(phenylene oxide) (PPO) polymers that were crosslinked via a strategy that introduced crosslinks into the noncharged regions of the membrane, followed by a series of solvent exchange steps to produce membranes with different solvent uptake from the same starting material. In a further aspect, these membranes control organic solvent swelling in the noncharged regions of the polymer, as opposed to other approaches that crosslink the charged regions of the polymer.

In a further aspect, the disclosed methods can yield different final membranes prepared from a single starting polymer with a range of solvent uptake properties. In a further aspect, the disclosed membranes are mechanically robust and have high total fixed charge density when compared to existing membranes. In a further aspect, and without wishing to be bound by theory, the high total fixed charge density of the disclosed membranes facilitate ionic conduction.

In one aspect, disclosed herein is a cross-linked blended membrane composition including at least the following:
a blend of a first polymer and a second polymer, wherein the first polymer is a cross-linked polymer, and wherein the first polymer has a structure represented by a formula:

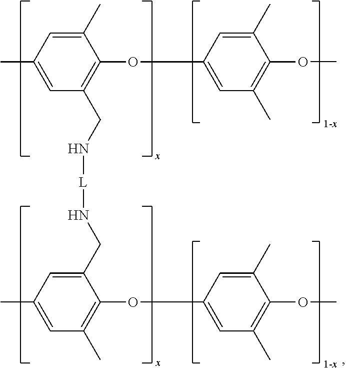

wherein x has a value from about 0.2 to about 0.9; and wherein L is a structure represented by a formula selected from:

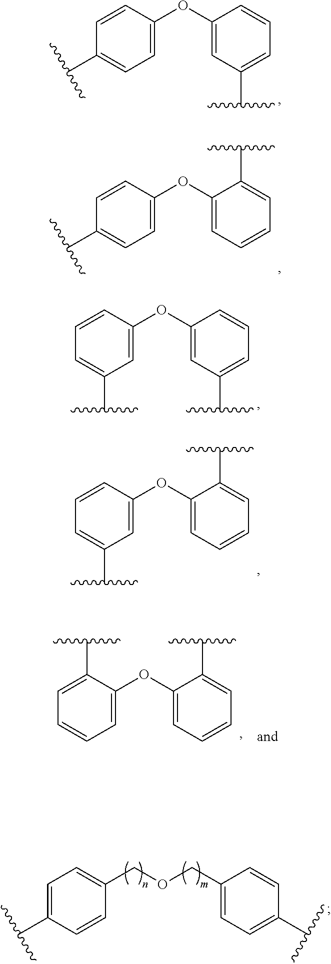

wherein each of n and m is an integer independently selected from 0, 1, 2, and 3; wherein the second polymer has a structure represented by a formula:

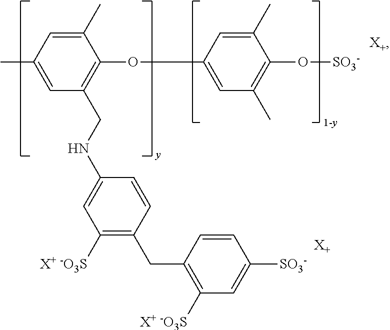

wherein y has a value from about 0.02 to about 0.6; and wherein X⁺ is a cation selected from H⁺, an alkali metal cation, and combinations thereof.

In another aspect, also disclosed are membranes including the disclosed membrane compositions. In one aspect, conductivity can be adjusted by adjusting variables during manufacturing of the membranes (e.g. crosslinker concentration, degree of Br functionalization, reaction temperature). In a further aspect, it is desirable to have high conductivity in the disclosed membranes.

In still another aspect, permeability of the membranes can be adjusted during manufacturing of the membranes. In an aspect, low permeability or selective permeability prevents crossover of undesired cations or reactants. In one aspect, the membranes are essentially non-porous to non-target ions and/or compounds.

In one aspect, the membranes can be less than or equal to about 100 μm in thickness, or can be from about 20 to about 100 μm in thickness, about 30 to about 80 μm in thickness, or about 50 to about 80 μm in thickness.

### C. REDOX FLOW BATTERY

The presently disclosed ion conducting polymer and the IEM thereof can be used in a variety of electrochemical and other applications. For example, when processed as a solid polymer electrolyte, the conductivity of the presently disclosed ion conducting polymer is suitable for polymer battery applications, including as a lithium ion or other alkali ion conducting electrolyte. The presently disclosed membranes do not have significant mass loss or decomposition until about 400° C. This high thermal stability suggests that the polymer membranes of the ion conducting polymer can be used as a high temperature alkali ion conducting electrolyte. The stability of the membranes in organic solvents and their selective transport for different cations suggests that the material can also be useful for electrochemically driven separation processes involving the separation of cations in organic solvents, such as in waste streams from chemical processing facilities. The charge density and stability of the membranes in aqueous electrolytes indicates that the presently disclosed membranes can be used in devices and apparatus for desalination processes, such as reverse osmosis, nanofiltration, membrane capacitive deionization or electrodialysis, as well as for electromembrane processes, such as reverse electrodialysis and concentration batteries.

In some embodiments, the presently disclosed subject matter provides a battery, fuel cell, or separation device comprising an IEM disclosed hereinabove, i.e., comprising, consisting essentially of, or consisting of a modified PPO polymer as described herein.

In some embodiments, the presently disclosed subject matter provides a RFB comprising the presently disclosed IEM. The RFB can be an aqueous or non-aqueous (or organic) RFB. In some embodiments, the battery comprises, in addition to the IEM, a positive electrode; a positive electrolyte comprising a first redox active composition, wherein said positive electrolyte is in contact with the positive electrode; a negative electrode; and a negative electrolyte comprising a second redox active composition, wherein said negative electrode is in contact with the negative electrode; wherein the IEM is interposed between the positive electrode and the negative electrode.

Any suitable material can be used for the positive electrode and the negative electrode. In some embodiments, each electrode comprises, consists essentially of, or consists of a metal, a carbon material, an electroconductive polymer, or a mixture thereof. In some embodiments, the positive and/or negative electrodes comprise, consist essentially of, or consist of a metal, such as aluminum, platinum, copper, nickel or stainless steel. Suitable electrode carbon materials include, but are not limited to, carbon black, activated carbon, amorphous carbon, graphite, graphene, or a nanostructured carbon material. The electrodes can be porous, fluted, or smooth.

In some embodiments, the battery is a non-aqueous RFB and the positive electrode, which can act as a current collector, is immersed in the positive electrolyte (or “catholyte”) comprising an electrochemically stable organic solvent, and the negative electrode, which can also function as a current collector, is immersed in the negative electrolyte (or “anolyte”), which also comprises an electrochemically stable organic solvent. The IEM partitions the negative electrode/anolyte from the positive electrode/catholyte. During charging and discharging, the electrolytes are circulated over their respective electrodes, while cations shuttle between the two electrolytes (through the IEM) to balance the charges that develop as a result of oxidation and reduction of redox active components in the electrolytes.

In some embodiments, the anolyte and the catholyte both comprise a redox active component and an electrolyte salt (i.e., a single salt or a combination of two or more different salts). In some embodiments, the redox active component of the catholyte is selected to have a higher redox potential than the redox reactive component of the anolyte.

In some embodiments, the positive electrolyte and the negative electrolyte each comprise an electrochemically stable solvent selected from the group comprising organic carbonates, such as ethylene carbonate, propylene carbonate, dimethyl carbonate, diethyl carbonate, and ethyl methyl carbonate; as well as, for example, ethers, esters, and nitriles (e.g., acetonitrile). Exemplary ethers include, but are not limited to dimethoxyethane, diethoxyethane, dibutoxyethane, diglyme (i.e., diethylene glycol dimethyl ether), triglyme (i.e., triethylene glycol dimethyl ether), tetraglyme (i.e., tetraethylene glycol dimethyl ether), tetrahydrofuran, 2-methyltetrahydrofuran, 2,5-dimethyltetrahydrofuran, 1,3-dioxolane, and 4-methyl-1,3-dioxolane. In some embodiments, the solvent is selected from the group comprising acetonitrile, dimethylacetamide, diethyl carbonate, dimethyl carbonate (DMC), y-butyrolactone (GBL), propylene carbonate (PC), ethylene carbonate (EC), N-methyl-2-pyrrolidone (NMP), fluoroethylene carbonate, N,N-dimethylacetamide, and mixtures thereof. In some embodiments, the positive electrolyte and the negative electrolyte each comprise the same solvent.

In some embodiments, the positive electrolyte and/or the negative electrolyte comprise one or more electrolyte salt or mixtures thereof. The electrolyte salts can comprise, for example, alkali metal salts, alkaline earth salts, organic salts, and the like. In some embodiments, the electrolyte salts are alkali metal salts (e.g., lithium salts such as lithium tetrafluoroborate or lithium hexafluorophosphate, or sodium salts). The electrolyte salt can aid in maintaining a charge balance between the negative electrolyte and the positive electrolyte in the positive compartment without, however, participating in a redox reaction. In general, suitable electrolyte salts are chemically inert over the range of potential in the RFB, have high ionic conductivity to ensure low resistance to the passage of current, and do not obstruct electron exchange on the electrode surfaces.

In some embodiments, the redox active composition comprises a metal coordination cation coordinated to a number of redox-active ligands and an anion. The metal coordination cation can comprise any transition metal ion, such as iron, copper, or manganese. The redox-active ligands can comprise an aminoalcohol and/or a dialcoholamine. The alkyl group of the alcohol can vary. For example, the aminoalcohol can comprise ethanolamine, butanolamine, hexanolamine, etc. A variety of redox-active species can be attached to or contained in the ligands. Many metallocenes, such as ferrocene, can be used. Also, transition metals coordinated to bypyridine groups can be used, such as tris(2,2′-bipyridine) nickel(II) or tris(2,2′bipyridine)iron(II). Other families of redox-active species, such as quinones, (2,2,6,6-tetramethyl-piperidin-I-yl)oxyl (TEMPO), aniline, or methylviologen, can also be attached to the ligand. For example, the anion can comprise iodide, ferricyanide, polyoxometallate, or peroxosulfate.

In some embodiments, the redox active component is selected from the group including, but not limited to, anisole, 4,4′-dimethyoxybiphenyl, 2,5-di-tertbutyl-1,4-dimethoxybenzene, 2,5-di-tert-butyl-1,4-bis(2-methoxyethoxy)benzene (DBBB), polyaniline, (2,2,6,6-tetramethylpiperidin-I-yl)oxy (TEMPO), a metallocene (e.g., ferrocene, nickelocene, cobaltocene), 9, 10-anthraquinone-2, 7-disulfonic acid, tetracyanoquinodimethane (TCNQ), 1,8-dicyrosy-9, I 0-anthraquinone-2, 7-disulfonic acid, quinoxaline, poly(2, 5-dimercapto-1,3, 4-thiadiazole), N-methy-1-phthalimide, pyrene-4,5,9,10-tetraone, benzoquinone, phenanthraquinone, napthoquinone, anthraquinone, 1,4,5,8-naphthalenetetracarboxylic dianhydride, 3,4,9,10-perylenetetracarboxylic dianhydride, 1,5-bis(2-(2-(2-methoxyethoxy)ethoxy)ethoxy)-anthracene-9, 10-dione, poly(anthraquinonylsulfide), pyromellitic anhydride, trans, trans-muconate, terephthalate, 4,4-tolanedicarboxylate, a metal bipyridine complex (e.g., tris(bipyridine) ruthenium, ([Ru(bpy)₃)])), and a metal acetylacetonate (e.g., vanadium acetylacetonate (V(acac)₃) or chromium acetylacetonate (Cr(acac)₃)). In some embodiments, the first and/or second redox composition comprise a metallocene. In some embodiments, the metallocene is ferrocene. In another aspect, the positive electrolyte and/or the negative electrolyte can include an electrolyte salt selected from the group consisting of lithium bis(fluorosulfonyl)imide (LiFSI), lithium tetrafluoroborate (LiBF₄), lithium hexafluorophosphate (LiPF₆,), lithium perchlorate (LiClO₄), lithium methyltrifluoromethanesulfonate (CF₃SO₃), lithium bis(trifluoromethylsulfonyl)imide [Li(CF₃SO₂)₂N], tetraethyl ammonium tetrafluoroborate (TEABF₄), tetrabutyl ammonium tetrafluoroborate (TBABF₄), and mixtures thereof. In an aspect, the first and/or second redox active compositions can include a metallocene such as, for example, ferrocene.

In some embodiments, the RFB can be charged by applying a potential difference across the positive and negative electrode, and the first redox active composition comprises a component that is oxidized and the second redox active composition comprises a component that is reduced. The RFB can be discharged by applying a potential difference across the positive and negative electrodes such that a component of the first redox active composition is reduced, and a component of the second redox active composition is oxidized.

In another aspect, disclosed herein is a battery, fuel cell, or separation device including the disclosed cross-linked blended membrane composition. In a further aspect, the battery can be a redox flow battery such as, for example, a non-aqueous redox flow battery.

### D. ENERGY STORAGE SYSTEM AND METHOD FOR STORING ENERGY

In some embodiments, the presently disclosed subject matter provides an energy storage system comprising one or more RFBs comprising the presently disclosed IEM. In some embodiments, the presently disclosed subject matter provides a stack comprising two or more RFBs. In some embodiments, the system is connected to an electrical grid. In some embodiments, the presently disclosed subject matter provides a method of storing energy, wherein the method comprises the use of an RFB of the presently disclosed subject matter or an energy storage system thereof, e.g., wherein the method comprises charging one or more RFB.

### E. METHOD FOR MAKING THE MEMBRANE COMPOSITION

In one aspect, the disclosed PPO polymers are first functionalized with Br, then the Br moieties are converted to phenoxy-aniline groups with high efficiency. Finally, diamino cross-linking is performed, resulting in extensive functionalization with higher charge densities than previously known membranes. In a further aspect, in the disclosed method, functionalization and cross-linking can be fine-tuned to avoid membrane brittleness.

In an aspect, disclosed herein is a method for making a cross-linked blended membrane composition, the method including at least the steps of: forming a pre-crosslinking mixture comprising a first polymer and a second polymer, wherein the first polymer has a structure represented by a formula:

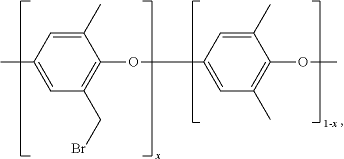

wherein x has a value from about 0.2 to about 0.9; wherein the second polymer has a structure represented by a formula:

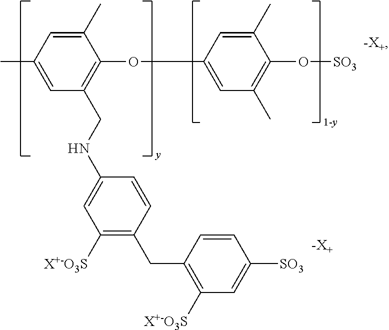

wherein y has a value from about 0.02 to about 0.6; and wherein X⁺ is a cation selected from H⁺, an alkali metal cation, and combinations thereof; forming a pre-crosslinked membrane from the pre-crosslinking mixture; drying the uncrosslinked membrane; pre-swelling the pre-crosslinked membrane with a swelling solution comprising a cross-linker and a first organic solvent, thereby forming a swollen pre-crosslinked membrane; and wherein the cross-linker is a structure represented by a formula selected from:

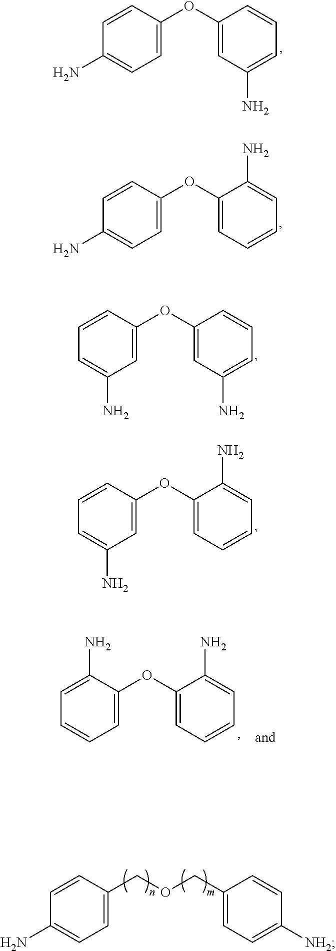

wherein each of n and m is an integer independently selected from 0, 1, 2, and 3; initiating a cross-linking reaction in the swollen pre-crosslinked membrane by adding an initiator in a second organic solvent thereto, thereby forming the cross-linked blended membrane composition; wherein the cross-linked blended membrane composition comprises the second polymer and a cross-linked polymer formed from reaction of the crosslinker; wherein the cross-linked polymer has a structure represented by a formula:

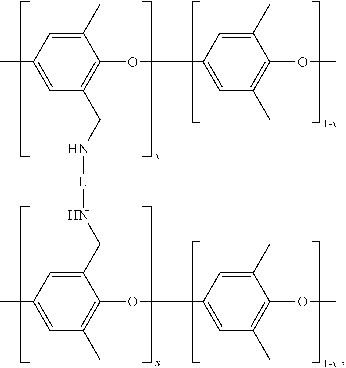

wherein L is a structure represented by a formula selected from:

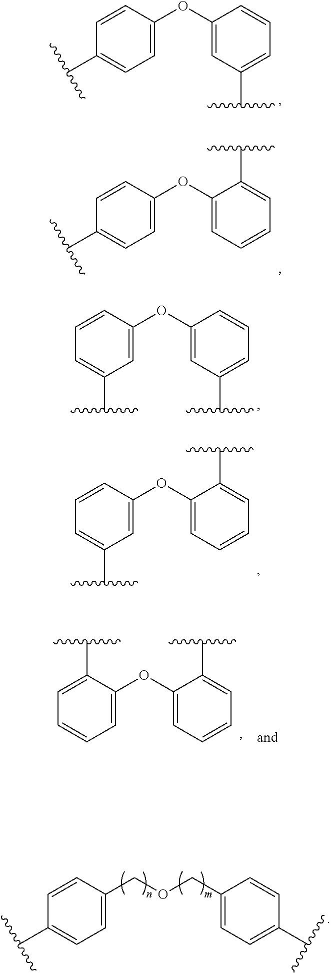

Also disclosed herein are cross-linked blended membrane compositions made by the disclosed metho; a battery, a fuel cell, or a separation device including the disclosed cross-linked blended membrane composition; and energy storage systems including the battery.

### F. REFERENCES

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.
Borodin, O.; et al. Quantum Chemistry and Molecular Dynamics Simulation Study of Dimethyl Carbonate: Ethylene Carbonate Electrolytes Doped with LiPF6. J. Phys. Chem. B 2009, 113, 1763-1776.
Bustamante, P.; et al. The Modified Extended Hansen Method to Determine Partial Solubility Parameters of Drugs Containing a Single Hydrogen Bonding Group and Their Sodium Derivatives: Benzoic Acid/Na and Ibuprofen/Na. Int. J. Pharm. 2000, 194 (1), 117-124.
Chang, K.; et al. Dielectric Permittivity Properties of Hydrated Polymers: Measurement and Connection to Ion Transport Properties. Ind. Eng. Chem. Res. 2020, 59, 5205-5217.
Chang, K.; et al. Increasing Salt Size Selectivity in Low Water Content Polymers via Polymer Backbone Dynamics. J. Memb. Sci. 2018, 552 (January), 43-50.
Chapman, N.; et al. Spectroscopic and Density Functional Theory Characterization of Common Lithium Salt Solvates in Carbonate Electrolytes for Lithium Batteries. J. Phys. Chem. C 2017, 121 (4), 2135-2148.
Childers, M. I.; et al. Stereoselective Epoxide Polymerization and Copolymerization. Chem. Rev. 2014, 114 (16), 8129-8152.
Coessens, V.; et al. Functional Polymers by Atom Transfer Radical Polymerization. Prog. Polym. Sci. 2001, 26 (3), 337-377.
Cohen, M. H.; et al. Molecular Transport in Liquids and Glasses. J. Chem. Phys. 1959, 31, 1164-1169.
Darling, R. M.; et al. Pathways to Low-Cost Electrochemical Energy Storage: A Comparison of Aqueous and Nonaqueous Flow Batteries. Energy Environ. Sci. 2014, 7 (11), 3459-3477.
Darling, R.; et al. Transport Property Requirements for Flow Battery Separators. J. Electrochem. Soc. 2016, 163 (1), A5029-A5040.
Ding, M. S.; et al. Liquid/Solid Phase Diagrams of Binary Carbonates for Lithium Batteries Part II. J. Electrochem. Soc. 2001, 148, 299-304.
Doyle, M.; et al. Ionic Conductivity of Nonaqueous Solvent-Swollen Ionomer Membranes Based on Fluorosulfonate, Fluorocarboxylate, and Sulfonate Fixed Ion Groups. J. Phys. Chem. B 2001, 105 (39), 9387-9394.
Doyle, M.; et al. Relationship between Ionic Conductivity of Perfluorinated Ionomeric Membranes and Nonaqueous Solvent Properties. J. Memb. Sci. 2001, 184 (2), 257-273.
Erb, A. J.; et al. Gas Sorption and Transport in Polysulfone. J. Membr. Sci. 1981, 8, 11-22.
Escalante-García, I. L.; et al. Performance of a Non-Aqueous Vanadium Acetylacetonate Prototype Redox Flow Battery: Examination of Separators and Capacity Decay. J. Electrochem. Soc. 2015, 162 (3), A363-A372.
Gagliardi, L. G.; et al. Static Dielectric Constants of Acetonitrile/Water Mixtures at Different Temperatures and Debye-Hückel A and AOB Parameters for Activity Coefficients. J. Chem. Eng. Data 2007, 52 (3), 1103-1107.
Geise, G. M.; et al. Ionic Resistance and Permselectivity Tradeoffs in Anion Exchange Membranes. ACS Appl. Mater. Interfaces 2013, 5 (20), 10294-10301.
Geise, G. M.; et al. Water Permeability and Water/Salt Selectivity Tradeoff in Polymers for Desalination. J. Memb. Sci. 2011, 369 (1-2), 130-138.
Geise, G. M.; et al. Fundamental Water and Salt Transport Properties of Polymeric Materials. Prog. Polym. Sci. 2014, 39 (1), 1-42.
Gharagheizi, F.; et al. Group Contribution-Based Method for Determination of Solubility Parameter of Nonelectrolyte Organic Compounds. Ind. Eng. Chem. Res. 2011, 50 (17), 10344-10349.
Gong, K.; et al. Nonaqueous Redox-Flow Batteries: Organic Solvents, Supporting Electrolytes, and Redox Pairs. Energy Environ. Sci. 2015, 8 (12), 3515-3530.
Gong, S. J.; et al Chitosan/Urushi Anion Exchange Membrane for a Non-Aqueous Redox Flow Battery. ChemistrySelect 2017, 2 (5), 1843-1849.
Guillen, G. R.; et al. Preparation and Characterization of Membranes Formed by Nonsolvent Induced Phase Separation: A Review. Ind. Eng. Chem. Res. 2011, 50 (7), 3798-3817.
Gupta, D.; et al. Chemical Redox of Lithium-Ion Solid Electroactive Material in a Packed Bed Flow Reactor. Chem. Eng. Sci. 2022, 251, 117443.
Ha, S.; et al. Estimating the System Price of Redox Flow Batteries for Grid Storage. J. Power Sources 2015, 296, 122-132.
Han, H. B. et al. Lithium Bis(Fluorosulfonyl)Imide (LiFSI) as Conducting Salt for Nonaqueous Liquid Electrolytes for Lithium-Ion Batteries: Physicochemical and Electrochemical Properties. J. Power Sources 2011, 196 (7), 3623-3632.
Han, S.-D.; et al. Electrolyte Solvation and Ionic Association: V. Acetonitrile-Lithium Bis(Fluorosulfonyl)Imide (LiFSI) Mixtures. J. Electrochem. Soc. 2014, 161 (14), A2042-A2053.
Herzberger, J.; et al. Polymerization of Ethylene Oxide, Propylene Oxide, and Other Alkylene Oxides: Synthesis, Novel Polymer Architectures, and Bioconjugation. Chem. Rev. 2016, 116 (4), 2170-2243.
Hudak, N. S.; et al. Through-Plane Conductivities of Membranes for Nonaqueous Redox Flow Batteries. J. Electrochem. Soc. 2015, 162, A2188-A2194.
Janisch, J.; et al. Consistent Diffusion Coefficients of Ferrocene in Some Non-Aqueous Solvents: Electrochemical Simultaneous Determination Together with Electrode Sizes and Comparison to Pulse-Gradient Spin-Echo NMR Results. J. Solid State Electrochem. 2011, 15 (10), 2083-2094.
Jauhiainen, T.-P. Effect of Bromine and Phosphorus Substituents on the Glass Transition Properties of Some Substituted Poly(Oxy-1,4-phenylenes). Angew. Makromol. Chem. 1982, 104, 117-127.
Jia, C.; et al. High-Energy Density Nonaqueous All Redox Flow Lithium Battery Enabled with a Polymeric Membrane. Sci. Adv. 2015, 1, No. e1500886.
Johlas, H.; et al. Storage Requirements for High Grid Penetration of Wind and Solar Power for the MISO Region of North America: A Case Study. Renew. Energy 2020, 146, 1315-1324.
Jung, J.; et al. Highly Selective Composite Membranes Using Ladder-like Structured Polysilsesquioxane for a Non-Aqueous Redox Flow Battery. J. Memb. Sci. 2019, No. September, 117520.
Kim, D. H.; et al. Pore-Filled Anion-Exchange Membranes for Non-Aqueous Redox Flow Batteries with Dual-Metal-Complex Redox Shuttles. J. Memb. Sci. 2014, 454, 44-50.
Kim, D.; et al. Structural Effects of Anion Exchange Composite Membranes in Non-Aqueous Redox Flow Batteries. J. Memb. Sci. 2018, 564 (April), 523-531.
Koenig, G. M. et al, International Patent Application Serial No. PCT/US2021/023280, entitled “ION SELECTIVE MEMBRANES FOR ORGANIC ELECTROCHEMICAL PROCESSES”, filed Mar. 19, 2021; Publication No. WO 2021/188977, Sep. 23, 2021.
Kondou, S. et al. Li-Ion Transport and Solvation of a Li Salt of Weakly Coordinating Polyanions in Ethylene Carbonate/Dimethyl Carbonate Mixtures. ACS Appl. Mater. Interfaces 2022, 14 (16), 18324-18334.
Kwon, H.-G.; et al. Crosslinked Poly(Arylene Ether Ketone) Membrane with High Anion Conductivity and Selectivity for Non-Aqueous Redox Flow Batteries. J. Memb. Sci. 2021, 620, 118928.
Lafitte, B.; et al. Proton-Conducting Aromatic Polymers Carrying Hypersulfonated Side Chains for Fuel Cell Applications. Adv. Funct. Mater. 2007, 17 (15), 2823-2834.
Lehmann, M. L.; et al. Membrane Design for Non-Aqueous Redox Flow Batteries: Current Status and Path Forward. Chem 2022, 8 (6), 1611-1636.
Lehmann, M. L.; et al. Unraveling Ion Transport in Trifluoromethanesulfonimide Pentablock Copolymer Membranes in Nonaqueous Electrolytes. Macromolecules 2022, 55, 7740-7751.
Lehmann, M.; et al. Unraveling Ion Transport in Pentablock Copolymer Membranes for Non-Aqueous Redox Flow Batteries. ECS Meet. Abstr. 2021, MA2021-02 (1), 109-109.
Li, N.; et al. Comb-Shaped Polymers to Enhance Hydroxide Transport in Anion Exchange Membranes. Energy Environ. Sci. 2012, 5 (7), 7888-7892.
Li, Y.; et al. Crosslinked Anion Exchange Membranes Prepared from Poly(Phenylene Oxide) (PPO) for Non-Aqueous Redox Flow Batteries. J. Power Sources 2018, 378 (December 2017), 338-344.
Luo, J.; et al. Status and Prospects of Organic Redox Flow Batteries toward Sustainable Energy Storage. ACS Energy Lett. 2019, 4 (9), 2220-2240.
Machado, C. A.; et al. Redox Flow Battery Membranes: Improving Battery Performance by Leveraging Structure-Property Relationships. ACS Energy Lett. 2021, 6 (1), 158-176.
Matsumoto, K.; et al. Synthesis of Networked Polymers by Copolymerization of Monoepoxy-Substituted Lithium Sulfonylimide and Diepoxy-Substituted Poly(Ethylene Glycol), and Their Properties. J. Polym. Sci. Part A Polym. Chem. 2011, 49 (8), 1874-1880.
Maurya, S.; et al. Anion Exchange Membrane Prepared from Simultaneous Polymerization and Quaternization of 4-Vinyl Pyridine for Non-Aqueous Vanadium Redox Flow Battery Applications. J. Power Sources 2014, 255, 325-334.
McCormack, et al. Thermodynamic Interactions as a Descriptor of Cross-Over in Nonaqueous Redox Flow Battery Membranes. ACS Appl. Mater. Interfaces 2021, 13, 49331-49339.
McCormack, P. M.; et al. Conductivity, Permeability, and Stability Properties of Chemically Tailored Poly(Phenylene Oxide) Membranes for Li+ Conductive Non-Aqueous Redox Flow Battery Separators. J. Power Sources 2020, 460, 228107.
Mulder, M. Basic Principles of Membrane Technology, 2nd ed.; Springer Netherlands, 1996.
Mushtaq, K.; et al. In-Situ Crossover Diagnostics to Assess Membrane Efficacy for Non-Aqueous Redox Flow Battery. J. Energy Storage 2021, 40, No. 102713.
Park, J.-S.; et al. Performance of Solid Alkaline Fuel Cells Employing Anion-Exchange Membranes. J. Power Sources 2008, 178, 620-626.
Paul, M.; et al. Synthesis and Crosslinking of Partially Disulfonated Poly(Arylene Ether Sulfone) Random Copolymers as Candidates for Chlorine Resistant Reverse Osmosis Membranes. Polymer (Guildf). 2008, 49 (9), 2243-2252.
Perea, J. D.; et al. Combined Computational Approach Based on Density Functional Theory and Artificial Neural Networks for Predicting the Solubility Parameters of Fullerenes. J. Phys. Chem. B 2016, 120 (19), 4431-4438.
Robeson, L. M.; et al. Upper Bound Relationship for Proton Exchange Membranes: Empirical Relationship and Relevance of Phase Separated Blends. J. Memb. Sci. 2007, 302 (1-2), 70-77.
Shi, Y.; et al. Recent Development of Membrane for Vanadium Redox Flow Battery Applications: A Review. Appl. Energy 2019, 238, 202-224.
Small, L. J.; et al. Diels Alder Polyphenylene Anion Exchange Membrane for Nonaqueous Redox Flow Batteries. J. Electrochem. Soc. 2016, 163 (1), A5106-A5111.
Stefanis, E.; et al. A New Expanded Solubility Parameter Approach. Int. J. Pharm. 2012, 426 (1-2), 29-43.
Stefanis, E.; et al. Prediction of Hansen Solubility Parameters with a New Group-Contribution Method. Int. J. Thermophys. 2008, 29 (2), 568-585.
Su, L.; et al. An Investigation of the Ionic Conductivity and Species Crossover of Lithiated Nafion 117 in Nonaqueous Electrolytes. J. Electrochem. Soc. 2016, 163 (1), A5253-A5262.
Tung, S. et al. Nanoporous Aramid Nanofibre Separators for Nonaqueous Redox Flow Batteries. Nat. Commun. 2018, 9 (1), 4193.
Weber, A. Z.; et al. Redox Flow Batteries: A Review. J. Appl. Electrochem. 2011, 41 (10), 1137-1164.
Wei, X.; et al. Materials and Systems for Organic Redox Flow Batteries: Status and Challenges. ACS Energy Lett. 2017, 2 (9), 2187-2204.
Wilke, C. R.; et al. Correlation of Diffusion Coefficients in Dilute Solutions. AIChE J. 1955, 1 (2), 264-270.
Xie, W.; et al. Influence of Processing History on Water and Salt Transport Properties of Disulfonated Polysulfone Random Copolymers. Polymer 2012, 53, 1581-1592.
Xie, W.; et al. Effect of Free Volume on Water and Salt Transport Properties in Directly Copolymerized Disulfonated Poly(Arylene Ether Sulfone) Random Copolymers. Macromolecules 2011, 44 (11), 4428-4438.
Xiong, P.; et al. A Chemistry and Microstructure Perspective on Ion-Conducting Membranes for Redox Flow Batteries. Angew. Chem., Int. Ed. 2021, 60, 24770-24798.
Yasuda, H.; et al. Permeability of Solutes through Hydrated Polymer Membranes. Part 1. Diffusion of Sodium Chloride. Die Makromol. Chemie 1968, 118 (2858), 19-35.
Ye, J.; et al. Redox Targeting-Based Flow Batteries. J. Phys. D. Appl. Phys. 2019, 52 (44), 443001.
Yousif, M.; et al. Least Cost Combinations of Solar Power, Wind Power, and Energy Storage System for Powering Large-Scale Grid. J. Power Sources 2019, 412 (November 2018), 710-716.
Yuan, J.; et al. Membranes in Non-Aqueous Redox Flow Battery: A Review. J. Power Sources 2021, 500 (May), 229983.
Zhang, F.; et al. Redox Targeting of Energy Materials for Energy Storage and Conversion. Adv. Mater. 2022, 34 (25), 2104562.
Zhang, H.; et al. Modeling the Water Permeability and Water/Salt Selectivity Tradeoff in Polymer Membranes. J. Memb. Sci. 2016, 520, 790-800.
Zhang, L.; et al. Emerging Chemistries and Molecular Designs for Flow Batteries. Nat. Rev. Chem. 2022, 6 (8), 524-543.
Zhang, X.; et al. An Ab Initio Molecular Dynamics Study of the Solvation Structure and Ultrafast Dynamics of Lithium Salts in Organic Carbonates: A Comparison between Linear and Cyclic Carbonates. J. Chem. Phys. 2019, 150 (18).
Zhou, M.; et al. Nernstian-Potential-Driven Redox-Targeting Reactions of Battery Materials. Chem 2017, 3 (6), 1036-1049.
Zhu, Y. G.; et al. Unleashing the Power and Energy of LiFePO4-Based Redox Flow Lithium Battery with a Bifunctional Redox Mediator. J. Am. Chem. Soc. 2017, 139 (18), 6286-6289.
Ziegler, M. S.; et al. Storage Requirements and Costs of Shaping Renewable Energy Toward Grid Decarbonization. Joule 2019, 3, 2134-2153.

### G. ASPECTS

The following listing of exemplary aspects supports and is supported by the disclosure provided herein.

Aspect 1. A cross-linked blended membrane composition comprising: a blend of a first polymer and a second polymer, wherein the first polymer is a cross-linked polymer; and wherein the first polymer has a structure represented by a formula:

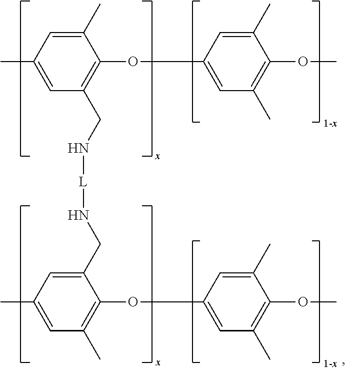

wherein x has a value from about 0.2 to about 0.9; and wherein L is a structure represented by a formula selected from:

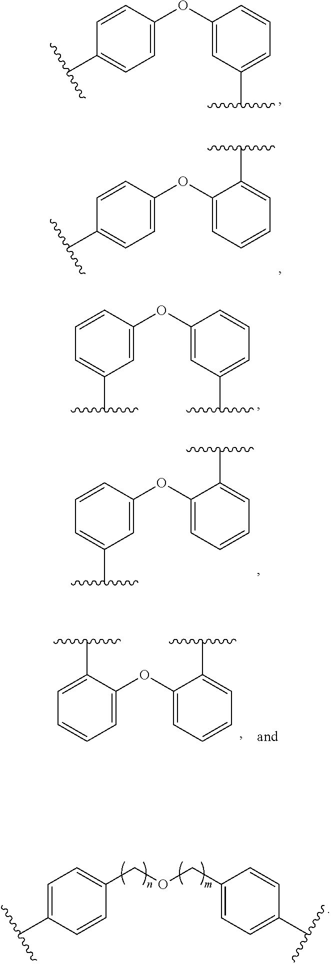

wherein each of n and m is an integer independently selected from 0, 1, 2, and 3;
   wherein the second polymer has a structure represented by a formula:

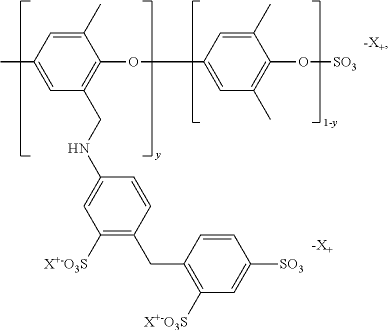

wherein y has a value from about 0.02 to about 0.6; and wherein X⁺ is a cation selected from H⁺, an alkali metal cation, and combinations thereof.

Aspect 2. The cross-linked blended membrane composition of Aspect 1, wherein L is a structure represented by a formula selected from:

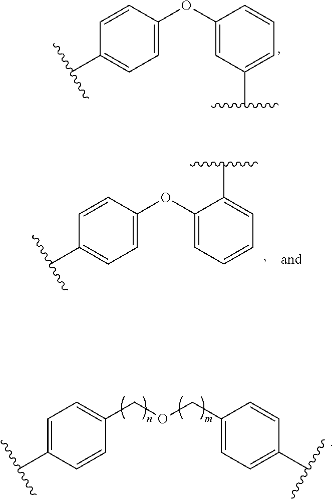

Aspect 3. The cross-linked blended membrane composition of Aspect 2, wherein L is a structure represented by a formula:

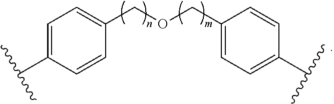

Aspect 4. The cross-linked blended membrane composition of any one of Aspect 1-Aspect 3, wherein each of n and m is an integer independently selected from 0, 1, and 2.

Aspect 5. The cross-linked blended membrane composition of Aspect 4, wherein each of n and m is an integer independently selected from 0 and 1.

Aspect 6. The cross-linked blended membrane composition of any one of Aspect 1-Aspect 5, wherein each of n and m is 0; and wherein L is a structure represented by a formula:

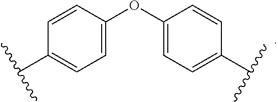 [SMILES: *c1ccc(Oc2ccc(*)cc2)cc1 ; "."]

Aspect 7. The cross-linked blended membrane composition of any one of Aspect 1-Aspect 6, wherein X⁺ is selected from H⁺, Li⁺, Na⁺, and K⁺.

Aspect 8. The cross-linked blended membrane composition of Aspect 7, wherein X⁺ is selected from H⁺, Li⁺, Na⁺, and K⁺.

Aspect 9. The cross-linked blended membrane composition of Aspect 7, wherein X⁺ is selected from H⁺, Li⁺, Na⁺, and combinations thereof.

Aspect 10. The cross-linked blended membrane composition of Aspect 7, wherein X⁺ is selected from H⁺, Li⁺, and combinations thereof.

Aspect 11. The cross-linked blended membrane composition of Aspect 7, wherein X⁺ is H⁺.

Aspect 12. The cross-linked blended membrane composition of Aspect 7, wherein X⁺ is Li⁺.

Aspect 13. The cross-linked blended membrane composition of any one of Aspect 1-Aspect 12, wherein x has a value from about 0.5 to about 0.8.

Aspect 14. The cross-linked blended membrane composition of Aspect 13, wherein x has a value from about 0.5 to about 0.7.

Aspect 15. The cross-linked blended membrane composition of Aspect 13, wherein x has a value from about 0.6 to about 0.8.

Aspect 16. The cross-linked blended membrane composition of Aspect 13, wherein x has a value from about 0.7 to about 0.8.

Aspect 17. The cross-linked blended membrane composition of any one of Aspect 1-Aspect 16, wherein y has a value from about 0.03 to about 0.4.

Aspect 18. The cross-linked blended membrane composition of Aspect 17, wherein y has a value from about 0.04 to about 0.3.

Aspect 19. The cross-linked blended membrane composition of Aspect 17, wherein y has a value from about 0.04 to about 0.2.

Aspect 20. The cross-linked blended membrane composition of Aspect 17, wherein y has a value from about 0.04 to about 0.1.

Aspect 21. The cross-linked blended membrane composition of Aspect 17, wherein y has a value from about 0.04 to about 0.09.

Aspect 22. The cross-linked blended membrane composition of Aspect 17, wherein y has a value from about 0.05 to about 0.4.

Aspect 23. The cross-linked blended membrane composition of Aspect 17, wherein y has a value from about 0.06 to about 0.4.

Aspect 24. The cross-linked blended membrane composition of Aspect 17, wherein y has a value from about 0.07 to about 0.4.

Aspect 25. The cross-linked blended membrane composition of Aspect 17, wherein y has a value from about 0.08 to about 0.4.

Aspect 26. The cross-linked blended membrane composition of Aspect 17, wherein y has a value from about 0.09 to about 0.4.

Aspect 27. The cross-linked blended membrane composition of Aspect 17, wherein y has a value from about 0.1 to about 0.4.

Aspect 28. The cross-linked blended membrane composition of Aspect 17, wherein y has a value from about 0.2 to about 0.4.

Aspect 29. The cross-linked blended membrane composition of Aspect 17, wherein y has a value from about 0.3 to about 0.4.

Aspect 30. The cross-linked blended membrane composition of any one of Aspect 1-Aspect 29, wherein the first polymer is present in an amount of about 5 wt % to about 40 wt %; wherein the second polymer is present in an amount of about 95 wt % to about 60 wt %; wherein a total wt % is 100 wt %; and wherein the total wt % is based on a total weight of the first polymer and the second polymer.

Aspect 31. The cross-linked blended membrane composition of Aspect 30, wherein the first polymer is present in an amount of about 10 wt % to about 40 wt %.

Aspect 32. The cross-linked blended membrane composition of Aspect 30, wherein the first polymer is present in an amount of about 10 wt % to about 35 wt %.

Aspect 33. The cross-linked blended membrane composition of Aspect 30, wherein the first polymer is present in an amount of about 10 wt % to about 35 wt %.

Aspect 34. The cross-linked blended membrane composition of Aspect 30, wherein the first polymer is present in an amount of about 5 wt % to about 35 wt %.

Aspect 35. The cross-linked blended membrane composition of Aspect 30, wherein the first polymer is present in an amount of about 5 wt % to about 30 wt %.

Aspect 36. The cross-linked blended membrane composition of Aspect 30, wherein the first polymer is present in an amount of about 15 wt % to about 25 wt %.

Aspect 37. The cross-linked blended membrane composition of Aspect 30, wherein the first polymer is present in an amount of about 17.5 wt % to about 22.5 wt %.

Aspect 38. The cross-linked blended membrane composition of any one of Aspect 1-Aspect 37, wherein weight average molecular weight of the first polymer is from about 20 kDa to about 100 kDa.

Aspect 39. The cross-linked blended membrane composition of Aspect 38, wherein weight average molecular weight of the first polymer is from about 25 kDa to about 95 kDa.

Aspect 40. The cross-linked blended membrane composition of Aspect 38, wherein weight average molecular weight of the first polymer is from about 30 kDa to about 90 kDa.

Aspect 41. The cross-linked blended membrane composition of Aspect 38, wherein weight average molecular weight of the first polymer is from about 35 kDa to about 85 kDa.

Aspect 42. The cross-linked blended membrane composition of Aspect 38, wherein weight average molecular weight of the first polymer is from about 40 kDa to about 75 kDa.

Aspect 43. The cross-linked blended membrane composition of Aspect 38, wherein weight average molecular weight of the first polymer is from about 45 kDa to about 70 kDa.

Aspect 44. The cross-linked blended membrane composition of Aspect 38, wherein weight average molecular weight of the first polymer is from about 30 kDa to about 85 kDa.

Aspect 45. The cross-linked blended membrane composition of Aspect 38, wherein weight average molecular weight of the first polymer is from about 30 kDa to about 80 kDa.

Aspect 46. The cross-linked blended membrane composition of Aspect 38, wherein weight average molecular weight of the first polymer is from about 30 kDa to about 75 kDa.

Aspect 47. The cross-linked blended membrane composition of Aspect 38, wherein weight average molecular weight of the first polymer is from about 30 kDa to about 70 kDa.

Aspect 48. The cross-linked blended membrane composition of Aspect 38, wherein weight average molecular weight of the first polymer is from about 40 kDa to about 85 kDa.

Aspect 49. The cross-linked blended membrane composition of Aspect 38, wherein weight average molecular weight of the first polymer is from about 40 kDa to about 80 kDa.

Aspect 50. The cross-linked blended membrane composition of Aspect 38, wherein weight average molecular weight of the first polymer is from about 40 kDa to about 75 kDa.

Aspect 51. The cross-linked blended membrane composition of Aspect 38, wherein weight average molecular weight of the first polymer is from about 40 kDa to about 70 kDa.

Aspect 52. The cross-linked blended membrane composition of any one of Aspect 1-Aspect 51, wherein weight average molecular weight of the second polymer is from about 20 kDa to about 100 kDa.

Aspect 53. The cross-linked blended membrane composition of Aspect 52, wherein weight average molecular weight of the second polymer is from about 25 kDa to about 95 kDa.

Aspect 54. The cross-linked blended membrane composition of Aspect 52, wherein weight average molecular weight of the second polymer is from about 30 kDa to about 90 kDa.

Aspect 55. The cross-linked blended membrane composition of Aspect 52, wherein weight average molecular weight of the second polymer is from about 35 kDa to about 85 kDa.

Aspect 56. The cross-linked blended membrane composition of Aspect 52, wherein weight average molecular weight of the second polymer is from about 40 kDa to about 75 kDa.

Aspect 57. The cross-linked blended membrane composition of Aspect 52, wherein weight average molecular weight of the second polymer is from about 45 kDa to about 70 kDa.

Aspect 58. The cross-linked blended membrane composition of Aspect 52, wherein weight average molecular weight of the second polymer is from about 30 kDa to about 85 kDa.

Aspect 59. The cross-linked blended membrane composition of Aspect 52, wherein weight average molecular weight of the second polymer is from about 30 kDa to about 80 kDa.

Aspect 60. The cross-linked blended membrane composition of Aspect 52, wherein weight average molecular weight of the second polymer is from about 30 kDa to about 75 kDa.

Aspect 61. The cross-linked blended membrane composition of Aspect 52, wherein weight average molecular weight of the second polymer is from about 30 kDa to about 70 kDa.

Aspect 62. The cross-linked blended membrane composition of Aspect 52, wherein weight average molecular weight of the second polymer is from about 40 kDa to about 85 kDa.

Aspect 63. The cross-linked blended membrane composition of Aspect 52, wherein weight average molecular weight of the second polymer is from about 40 kDa to about 80 kDa.

Aspect 64. The cross-linked blended membrane composition of Aspect 52, wherein weight average molecular weight of the second polymer is from about 40 kDa to about 75 kDa.

Aspect 65. The cross-linked blended membrane composition of Aspect 52, wherein weight average molecular weight of the second polymer is from about 40 kDa to about 70 kDa.

Aspect 66. The cross-linked blended membrane composition of any one of Aspect 1-Aspect 65, wherein the dispersity of the first polymer is from about 1 to about 5.

Aspect 67. The cross-linked blended membrane composition of Aspect 66, wherein the dispersity of the first polymer is from about 1.5 to about 4.5.

Aspect 68. The cross-linked blended membrane composition of Aspect 66, wherein the dispersity of the first polymer is from about 1.5 to about 4.

Aspect 69. The cross-linked blended membrane composition of Aspect 66 wherein the dispersity of the first polymer is from about 2 to about 4.

Aspect 70. The cross-linked blended membrane composition of Aspect 66, wherein the dispersity of the first polymer is from about 2.5 to about 4.

Aspect 71. The cross-linked blended membrane composition of Aspect 66, wherein the dispersity of the first polymer is from about 3 to about 4.

Aspect 72. The cross-linked blended membrane composition of Aspect 66, wherein the dispersity of the first polymer is from about 2 to about 5.

Aspect 73. The cross-linked blended membrane composition of Aspect 66, wherein the dispersity of the first polymer is from about 2 to about 4.5.

Aspect 74. The cross-linked blended membrane composition of Aspect 66, wherein the dispersity of the first polymer is from about 2 to about 3.5.

Aspect 75. The cross-linked blended membrane composition of Aspect 66, wherein the dispersity of the first polymer is from about 2 to about 3.

Aspect 76. The cross-linked blended membrane composition of any one of Aspect 1-Aspect 75, wherein the dispersity of the second polymer is from about 1 to about 5.

Aspect 77. The cross-linked blended membrane composition of Aspect 76, wherein the dispersity of the second polymer is from about 1.5 to about 4.5.

Aspect 78. The cross-linked blended membrane composition of Aspect 76, wherein the dispersity of the second polymer is from about 1.5 to about 4.

Aspect 79. The cross-linked blended membrane composition of Aspect 76, wherein the dispersity of the second polymer is from about 2 to about 4.

Aspect 80. The cross-linked blended membrane composition of Aspect 76, wherein the dispersity of the second polymer is from about 2.5 to about 4.

Aspect 81. The cross-linked blended membrane composition of Aspect 76, wherein the dispersity of the second polymer is from about 3 to about 4.

Aspect 82. The cross-linked blended membrane composition of Aspect 76, wherein the dispersity of the second polymer is from about 2 to about 5.

Aspect 83. The cross-linked blended membrane composition of Aspect 76, wherein the dispersity of the second polymer is from about 2 to about 4.5.

Aspect 84. The cross-linked blended membrane composition of Aspect 76, wherein the dispersity of the second polymer is from about 2 to about 3.5.

Aspect 85. The cross-linked blended membrane composition of Aspect 76, wherein the dispersity of the second polymer is from about 2 to about 3.

Aspect 86. The cross-linked blended membrane composition of any one of Aspect 1-Aspect 85, wherein the cross-linked blended membrane composition has a thickness from about 1 μm to about 100 μm.

Aspect 87. The cross-linked blended membrane composition of Aspect 76, wherein the cross-linked blended membrane composition has a thickness from about 10 μm to about 100 μm.

Aspect 88. The cross-linked blended membrane composition of Aspect 76, wherein the cross-linked blended membrane composition has a thickness from about 20 μm to about 100 μm.

Aspect 89. The cross-linked blended membrane composition of Aspect 76, wherein the cross-linked blended membrane composition has a thickness from about 30 μm to about 100 μm.

Aspect 90. The cross-linked blended membrane composition of Aspect 76, wherein the cross-linked blended membrane composition has a thickness from about 40 μm to about 100 μm.

Aspect 91. The cross-linked blended membrane composition of Aspect 76, wherein the cross-linked blended membrane composition has a thickness from about 50 μm to about 100 μm.

Aspect 92. The cross-linked blended membrane composition of Aspect 76, wherein the cross-linked blended membrane composition has a thickness from about 10 μm to about 90 μm.

Aspect 93. The cross-linked blended membrane composition of Aspect 76, wherein the cross-linked blended membrane composition has a thickness from about 20 μm to about 90 μm.

Aspect 94. The cross-linked blended membrane composition of Aspect 76, wherein the cross-linked blended membrane composition has a thickness from about 30 μm to about 90 μm.

Aspect 95. The cross-linked blended membrane composition of Aspect 76, wherein the cross-linked blended membrane composition has a thickness from about 40 μm to about 90 μm.

Aspect 96. The cross-linked blended membrane composition of Aspect 76, wherein the cross-linked blended membrane composition has a thickness from about 50 μm to about 90 μm.

Aspect 97. The cross-linked blended membrane composition of Aspect 76, wherein the cross-linked blended membrane composition has a thickness from about 10 μm to about 80 μm.

Aspect 98. The cross-linked blended membrane composition of Aspect 76, wherein the cross-linked blended membrane composition has a thickness from about 20 μm to about 80 μm.

Aspect 99. The cross-linked blended membrane composition of Aspect 76, wherein the cross-linked blended membrane composition has a thickness from about 30 μm to about 80 μm.

Aspect 100. The cross-linked blended membrane composition of Aspect 76, wherein the cross-linked blended membrane composition has a thickness from about 40 μm to about 80 μm.

Aspect 101. The cross-linked blended membrane composition of Aspect 76, wherein the cross-linked blended membrane composition has a thickness from about 50 μm to about 80 μm.

Aspect 102. The cross-linked blended membrane composition of Aspect 76, wherein the cross-linked blended membrane composition has a thickness from about 10 μm to about 70 μm.

Aspect 103. The cross-linked blended membrane composition of Aspect 76, wherein the cross-linked blended membrane composition has a thickness from about 20 μm to about 70 μm.

Aspect 104. The cross-linked blended membrane composition of Aspect 76, wherein the cross-linked blended membrane composition has a thickness from about 30 μm to about 70 μm.

Aspect 105. The cross-linked blended membrane composition of Aspect 76, wherein the cross-linked blended membrane composition has a thickness from about 40 μm to about 70 μm.

Aspect 106. The cross-linked blended membrane composition of Aspect 76, wherein the cross-linked blended membrane composition has a thickness from about 50 μm to about 70 μm.

Aspect 107. The cross-linked blended membrane composition of any one of Aspect 1-Aspect 106, wherein the cross-linked blended membrane composition has a lithium-ion conductivity of greater than or equal to about 0.05 mS cm-1 where determined in accordance with the methods disclosed herein.

Aspect 108. The cross-linked blended membrane composition of Aspect 107, wherein the cross-linked blended membrane composition has a lithium-ion conductivity of greater than or equal to about 0.10 mS cm⁻¹.

Aspect 109. The cross-linked blended membrane composition of Aspect 107, wherein the cross-linked blended membrane composition has a lithium-ion conductivity of greater than or equal to about 0.11 mS cm⁻¹.

Aspect 110. The cross-linked blended membrane composition of Aspect 107, wherein the cross-linked blended membrane composition has a lithium-ion conductivity of greater than or equal to about 0.12 mS cm⁻¹.

Aspect 111. The cross-linked blended membrane composition of Aspect 107, wherein the cross-linked blended membrane composition has a lithium-ion conductivity of greater than or equal to about 0.13 mS cm⁻¹.

Aspect 112. The cross-linked blended membrane composition of Aspect 107, wherein the cross-linked blended membrane composition has a lithium-ion conductivity of greater than or equal to about 0.14 mS cm⁻¹.

Aspect 113. The cross-linked blended membrane composition of Aspect 107, wherein the cross-linked blended membrane composition has a lithium-ion conductivity of greater than or equal to about 0.15 mS cm⁻¹.

Aspect 114. The cross-linked blended membrane composition of Aspect 107, wherein the cross-linked blended membrane composition has a lithium-ion conductivity of greater than or equal to about 0.20 mS cm⁻¹.

Aspect 115. The cross-linked blended membrane composition of Aspect 107, wherein the cross-linked blended membrane composition has a lithium-ion conductivity of greater than or equal to about 0.25 mS cm⁻¹.

Aspect 116. The cross-linked blended membrane composition of Aspect 107, wherein the cross-linked blended membrane composition has a lithium-ion conductivity of greater than or equal to about 0.30 mS cm⁻¹.

Aspect 117. The cross-linked blended membrane composition of Aspect 107, wherein the cross-linked blended membrane composition has a lithium-ion conductivity of greater than or equal to about 0.40 mS cm⁻¹.

Aspect 118. The cross-linked blended membrane composition of Aspect 107, wherein the cross-linked blended membrane composition has a lithium-ion conductivity of greater than or equal to about 0.50 mS cm⁻¹.

Aspect 119. The cross-linked blended membrane composition of Aspect 107, wherein the cross-linked blended membrane composition has a lithium-ion conductivity from about 0.05 mS cm⁻¹ to about 1.00 mS cm⁻¹.

Aspect 120. The cross-linked blended membrane composition of Aspect 107, wherein the cross-linked blended membrane composition has a lithium-ion conductivity from about 0.10 mS cm⁻¹ to about 1.00 mS cm⁻¹.

Aspect 121. The cross-linked blended membrane composition of Aspect 107, wherein the cross-linked blended membrane composition has a lithium-ion conductivity from about 0.15 mS cm⁻¹ to about 1.00 mS cm⁻¹.

Aspect 122. The cross-linked blended membrane composition of Aspect 107, wherein the cross-linked blended membrane composition has a lithium-ion conductivity from about 0.20 mS cm⁻¹ to about 1.00 mS cm⁻¹.

Aspect 123. The cross-linked blended membrane composition of Aspect 107, wherein the cross-linked blended membrane composition has a lithium-ion conductivity from about 0.25 mS cm⁻¹ to about 1.00 mS cm⁻¹.

Aspect 124. The cross-linked blended membrane composition of Aspect 107, wherein the cross-linked blended membrane composition has a lithium-ion conductivity from about 0.30 mS cm⁻¹ to about 1.00 mS cm⁻¹.

Aspect 125. The cross-linked blended membrane composition of Aspect 107, wherein the cross-linked blended membrane composition has a lithium-ion conductivity from about 0.10 mS cm⁻¹ to about 0.90 mS cm⁻¹.

Aspect 126. The cross-linked blended membrane composition of Aspect 107, wherein the cross-linked blended membrane composition has a lithium-ion conductivity from about 0.15 mS cm⁻¹ to about 0.90 mS cm⁻¹.

Aspect 127. The cross-linked blended membrane composition of Aspect 107, wherein the cross-linked blended membrane composition has a lithium-ion conductivity from about 0.20 mS cm⁻¹ to about 0.90 mS cm⁻¹.

Aspect 128. The cross-linked blended membrane composition of Aspect 107, wherein the cross-linked blended membrane composition has a lithium-ion conductivity from about 0.25 mS cm⁻¹ to about 0.90 mS cm⁻¹.

Aspect 129. The cross-linked blended membrane composition of Aspect 107, wherein the cross-linked blended membrane composition has a lithium-ion conductivity from about 0.30 mS cm⁻¹ to about 0.90 mS cm⁻¹.

Aspect 130. The cross-linked blended membrane composition of Aspect 107, wherein the cross-linked blended membrane composition has a lithium-ion conductivity from about 0.10 mS cm⁻¹ to about 0.80 mS cm⁻¹.

Aspect 131. The cross-linked blended membrane composition of Aspect 107, wherein the cross-linked blended membrane composition has a lithium-ion conductivity from about 0.15 mS cm⁻¹ to about 0.80 mS cm⁻¹.

Aspect 132. The cross-linked blended membrane composition of Aspect 107, wherein the cross-linked blended membrane composition has a lithium-ion conductivity from about 0.20 mS cm⁻¹ to about 0.80 mS cm⁻¹.

Aspect 133. The cross-linked blended membrane composition of Aspect 107, wherein the cross-linked blended membrane composition has a lithium-ion conductivity from about 0.25 mS cm⁻¹ to about 0.80 mS cm⁻¹.

Aspect 134. The cross-linked blended membrane composition of Aspect 107, wherein the cross-linked blended membrane composition has a lithium-ion conductivity from about 0.30 mS cm⁻¹ to about 0.80 mS cm⁻¹.

Aspect 135. The cross-linked blended membrane composition of Aspect 107, wherein the cross-linked blended membrane composition has a lithium-ion conductivity from about 0.10 mS cm⁻¹ to about 0.70 mS cm⁻¹.

Aspect 136. The cross-linked blended membrane composition of Aspect 107, wherein the cross-linked blended membrane composition has a lithium-ion conductivity from about 0.15 mS cm⁻¹ to about 0.70 mS cm⁻¹.

Aspect 137. The cross-linked blended membrane composition of Aspect 107, wherein the cross-linked blended membrane composition has a lithium-ion conductivity from about 0.20 mS cm⁻¹ to about 0.70 mS cm⁻¹.

Aspect 138. The cross-linked blended membrane composition of Aspect 107, wherein the cross-linked blended membrane composition has a lithium-ion conductivity from about 0.25 mS cm⁻¹ to about 0.70 mS cm⁻¹.

Aspect 139. The cross-linked blended membrane composition of Aspect 107, wherein the cross-linked blended membrane composition has a lithium-ion conductivity from about 0.30 mS cm⁻¹ to about 0.70 mS cm⁻¹.

Aspect 140. The cross-linked blended membrane composition of any one of Aspect 1-Aspect 106, wherein the cross-linked blended membrane composition has a 4-hydroxy TEMPO permeability of from about 1×10-7 cm² s⁻¹ to about 1×10-12 cm² s⁻¹ wherein determined in accordance with the methods disclosed herein.

Aspect 141. The cross-linked blended membrane composition of Aspect 140, wherein the cross-linked blended membrane composition has a 4-hydroxy TEMPO permeability of from about 1×10-7 cm² s⁻¹ to about 1×10-11 cm² s⁻¹.

Aspect 142. The cross-linked blended membrane composition of Aspect 140, wherein the cross-linked blended membrane composition has a 4-hydroxy TEMPO permeability of from about 1×10-7 cm² s⁻¹ to about 1×10-10 cm² s⁻¹.

Aspect 143. The cross-linked blended membrane composition of Aspect 140, wherein the cross-linked blended membrane composition has a 4-hydroxy TEMPO permeability of from about 1×10-7 cm² s⁻¹ to about 1×10-9 cm² s⁻¹.

Aspect 144. The cross-linked blended membrane composition of Aspect 140, wherein the cross-linked blended membrane composition has a 4-hydroxy TEMPO permeability of from about 1×10-8 cm² s⁻¹ to about 1×10-11 cm² s⁻¹.

Aspect 145. The cross-linked blended membrane composition of Aspect 140, wherein the cross-linked blended membrane composition has a 4-hydroxy TEMPO permeability of from about 1×10-8 cm² s⁻¹ to about 1×10-10 cm² s⁻¹.

Aspect 146. The cross-linked blended membrane composition of Aspect 140, wherein the cross-linked blended membrane composition has a 4-hydroxy TEMPO permeability of from about 1×10-8 cm² s⁻¹ to about 1×10-9 cm² s⁻¹.

Aspect 147. A battery, fuel cell, or separation device comprising the cross-linked blended membrane composition of any one of Aspect 1-Aspect 146.

Aspect 148. The battery of Aspect 147, wherein the battery is a redox flow battery.

Aspect 149. The battery of Aspect 148, wherein the redox flow battery is a non-aqueous redox flow battery.

Aspect 150. A redox flow battery comprising: the cross-linked blended membrane composition any one of Aspects 1-Aspect 146; a positive electrode; a positive electrolyte comprising a first redox active composition, wherein the positive electrolyte is in contact with the positive electrode; a negative electrode; and a negative electrolyte comprising a second redox active composition, wherein the negative electrode is in contact with the negative electrode, and wherein the cross-linked blended membrane composition is interposed between the positive electrode and the negative electrode.

Aspect 151. The redox flow battery of Aspect 150, wherein the redox flow battery is a non-aqueous redox flow battery.

Aspect 152. The redox flow battery of Aspect 150 or Aspect 151, wherein the positive electrode and the negative electrode independently comprise a metal, a carbon material, an electro-conductive polymer, and combinations thereof.

Aspect 153. The redox flow battery of any one of Aspect 150-Aspect 152, wherein the positive electrolyte and the negative electrolyte each comprise a solvent independently selected from the group consisting of acetonitrile, dimethylacetamide, diethyl carbonate, dimethyl carbonate, γ-butyrolactone, propylene carbonate, ethylene carbonate, N-methyl-2-pyrrolidone, fluoroethylene carbonate, N, N-dimethylacetamide, and combinations thereof.

Aspect 154. The redox flow battery of Aspect 153, wherein the positive electrolyte and the negative electrolyte each comprise the same solvent.

Aspect 155. The redox flow battery of Aspect 153 or Aspect 154, wherein the positive electrolyte and the negative electrolyte each comprise a solvent independently selected from the group consisting of acetonitrile, dimethylacetamide, diethyl carbonate, dimethyl carbonate, and combinations thereof.

Aspect 156. The redox flow battery of Aspect 155, wherein the solvent is dimethyl carbonate.

Aspect 157. The redox flow battery of any one of Aspect 150-Aspect 156, wherein the positive electrolyte and/or the negative electrolyte comprise an electrolyte salt selected from the group consisting of lithium bis(fluorosulfonyl)imide, lithium tetrafluoroborate, lithium hexafluorophosphate, lithium perchlorate, lithium methyltrifluoromethanesulfonate, lithium bis(trifluoromethylsulfonyl)imide, tetraethyl ammonium tetrafluoroborate, tetrabutyl ammonium tetrafluoroborate, and combinations thereof.

Aspect 158. The redox flow battery of any one of Aspect 150-Aspect 157, wherein the first and/or second redox active compositions comprise a metallocene.

Aspect 159. The redox flow battery of Aspect 158, wherein the metallocene is a ferrocene.

Aspect 160. An energy storage system comprising the redox flow battery of Aspect 150, or a stack comprising a plurality thereof.

Aspect 161. The energy storage system of Aspect 160, wherein the energy storage system is connected to an electrical grid.

Aspect 162. A method of storing energy, the method comprising connecting the energy storage system of Aspect 160 to an electrical grid.

Aspect 163. A method for making a cross-linked blended membrane composition, the method comprising: forming a pre-crosslinking mixture comprising a first polymer and a second polymer, wherein the first polymer has a structure represented by a formula:

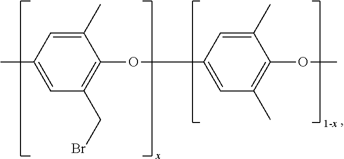

wherein x has a value from about 0.2 to about 0.9; wherein the second polymer has a structure represented by a formula:

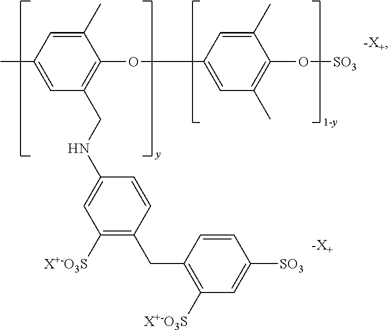

wherein y has a value from about 0.02 to about 0.6; and wherein X⁺ is a cation selected from H⁺, an alkali metal cation, and combinations thereof; forming a pre-crosslinked membrane from the pre-crosslinking mixture; drying the uncrosslinked membrane; pre-swelling the pre-crosslinked membrane with a swelling solution comprising a cross-linker and a first organic solvent, thereby forming a swollen pre-crosslinked membrane; and wherein the cross-linker is a structure represented by a formula selected from:

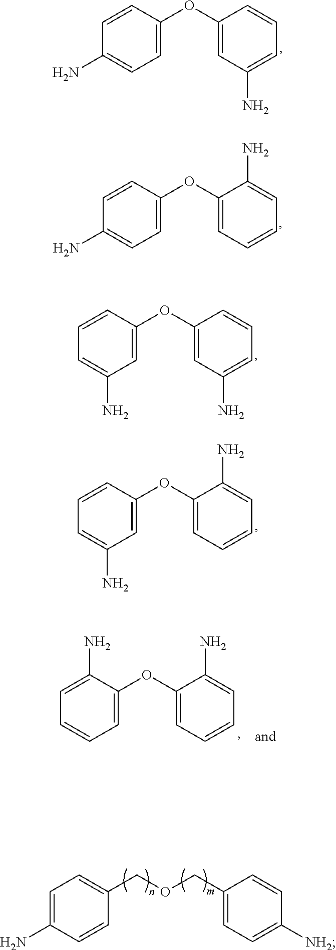

wherein each of n and m is an integer independently selected from 0, 1, 2, and 3; initiating a cross-linking reaction in the swollen pre-crosslinked membrane by adding an initiator in a second organic solvent thereto, thereby forming the cross-linked blended membrane composition; wherein the cross-linked blended membrane composition comprises the second polymer and a cross-linked polymer formed from reaction of the crosslinker; wherein the cross-linked polymer has a structure represented by a formula:

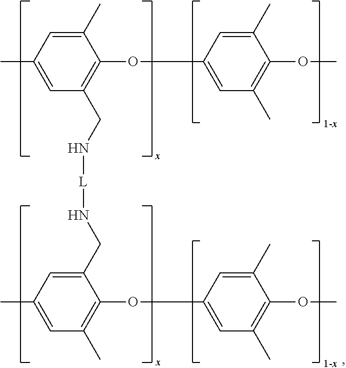

wherein L is a structure represented by a formula selected from:

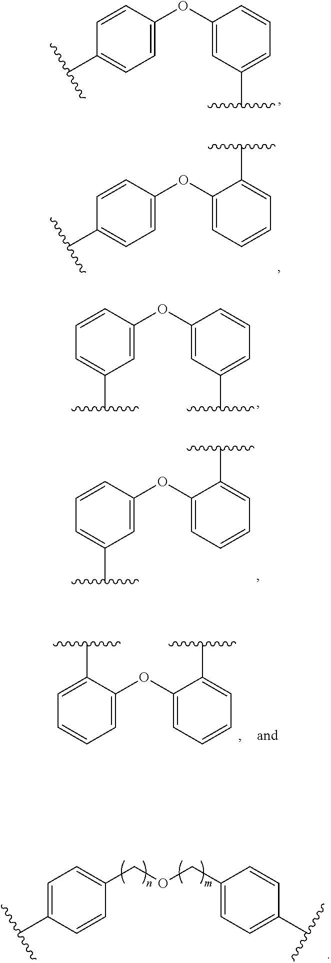

Aspect 164. The method of Aspect 1, wherein L is a structure represented by a formula selected from:

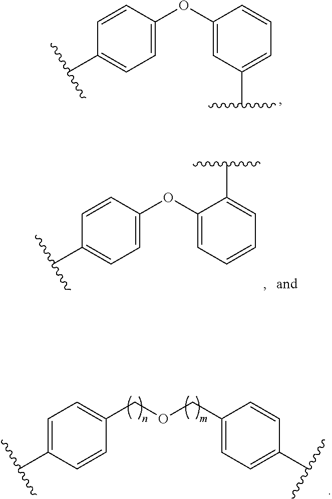

Aspect 165. The method of Aspect 164, wherein L is a structure represented by a formula:

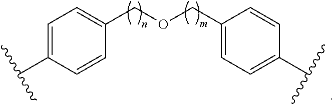

Aspect 166. The method of any one of Aspect 163-Aspect 165, wherein each of n and m is an integer independently selected from 0, 1, and 2.

Aspect 167. The method of Aspect 166, wherein each of n and m is an integer independently selected from 0 and 1.

Aspect 168. The method of any one of Aspect 163-Aspect 167, wherein each of n and m is 0; and wherein L is a structure represented by a formula:

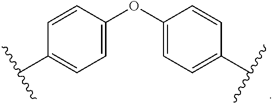 [SMILES: *c1ccc(Oc2ccc(*)cc2)cc1]

Aspect 169. The method of any one of Aspect 163-Aspect 168, wherein X⁺ is selected from H⁺, Li⁺, Na⁺, and K⁺.

Aspect 170. The method of Aspect 169, wherein X⁺ is selected from H⁺, Li⁺, Na⁺, and K⁺.

Aspect 171. The method of Aspect 169, wherein X⁺ is selected from H⁺, Li⁺, Na⁺, and combinations thereof.

Aspect 172. The method of Aspect 169, wherein X⁺ is selected from H⁺, Li⁺, and combinations thereof.

Aspect 173. The method of Aspect 169, wherein X⁺ is H⁺.

Aspect 174. The method of Aspect 169, wherein X⁺ is Li⁺.

Aspect 175. The method of any one of Aspect 163-Aspect 174, wherein x has a value from about 0.5 to about 0.8.

Aspect 176. The method of Aspect 175, wherein x has a value from about 0.5 to about 0.7.

Aspect 177. The method of Aspect 175, wherein x has a value from about 0.6 to about 0.8.

Aspect 178. The method of Aspect 175, wherein x has a value from about 0.7 to about 0.8.

Aspect 179. The method of any one of Aspect 163-Aspect 178, wherein y has a value from about 0.03 to about 0.4.

Aspect 180. The method of Aspect 179, wherein y has a value from about 0.04 to about 0.3.

Aspect 181. The method of Aspect 179, wherein y has a value from about 0.04 to about 0.2.

Aspect 182. The method of Aspect 179, wherein y has a value from about 0.04 to about 0.1.

Aspect 183. The method of Aspect 179, wherein y has a value from about 0.04 to about 0.09.

Aspect 184. The method of Aspect 179, wherein y has a value from about 0.05 to about 0.4.

Aspect 185. The method of Aspect 179, wherein y has a value from about 0.06 to about 0.4.

Aspect 186. The method of Aspect 179, wherein y has a value from about 0.07 to about 0.4.

Aspect 187. The method of Aspect 179, wherein y has a value from about 0.08 to about 0.4.

Aspect 188. The method of Aspect 179, wherein y has a value from about 0.09 to about 0.4.

Aspect 189. The method of Aspect 179, wherein y has a value from about 0.1 to about 0.4.

Aspect 190. The method of Aspect 179, wherein y has a value from about 0.2 to about 0.4.

Aspect 191. The method of Aspect 179, wherein y has a value from about 0.3 to about 0.4.

Aspect 192. The method of any one of Aspect 163-Aspect 191, wherein the first polymer is present in an amount of about 5 wt % to about 40 wt %; wherein the second polymer is present in an amount of about 95 wt % to about 60 wt %; wherein a total wt % is 100 wt %; and wherein the total wt % is based on a total weight of the first polymer and the second polymer.

Aspect 193. The method of Aspect 192, wherein the first polymer is present in an amount of about 10 wt % to about 40 wt %.

Aspect 194. The method of Aspect 192, wherein the first polymer is present in an amount of about 10 wt % to about 35 wt %.

Aspect 195. The method of Aspect 192, wherein the first polymer is present in an amount of about 10 wt % to about 35 wt %.

Aspect 196. The method of Aspect 192, wherein the first polymer is present in an amount of about 5 wt % to about 35 wt %.

Aspect 197. The method of Aspect 192, wherein the first polymer is present in an amount of about 5 wt % to about 30 wt %.

Aspect 198. The method of Aspect 192, wherein the first polymer is present in an amount of about 15 wt % to about 25 wt %.

Aspect 199. The method of Aspect 192, wherein the first polymer is present in an amount of about 17.5 wt % to about 22.5 wt %.

Aspect 200. The method of any one of Aspect 163-Aspect 37, wherein weight average molecular weight of the first polymer is from about 20 kDa to about 100 kDa.

Aspect 201. The method of Aspect 200, wherein weight average molecular weight of the first polymer is from about 25 kDa to about 95 kDa.

Aspect 202. The method of Aspect 200, wherein weight average molecular weight of the first polymer is from about 30 kDa to about 90 kDa.

Aspect 203. The method of Aspect 200, wherein weight average molecular weight of the first polymer is from about 35 kDa to about 85 kDa.

Aspect 204. The method of Aspect 200, wherein weight average molecular weight of the first polymer is from about 40 kDa to about 75 kDa.

Aspect 205. The method of Aspect 200, wherein weight average molecular weight of the first polymer is from about 45 kDa to about 70 kDa.

Aspect 206. The method of Aspect 200, wherein weight average molecular weight of the first polymer is from about 30 kDa to about 85 kDa.

Aspect 207. The method of Aspect 200, wherein weight average molecular weight of the first polymer is from about 30 kDa to about 80 kDa.

Aspect 208. The method of Aspect 200, wherein weight average molecular weight of the first polymer is from about 30 kDa to about 75 kDa.

Aspect 209. The method of Aspect 200, wherein weight average molecular weight of the first polymer is from about 30 kDa to about 70 kDa.

Aspect 210. The method of Aspect 200, wherein weight average molecular weight of the first polymer is from about 40 kDa to about 85 kDa.

Aspect 211. The method of Aspect 200, wherein weight average molecular weight of the first polymer is from about 40 kDa to about 80 kDa.

Aspect 212. The method of Aspect 200, wherein weight average molecular weight of the first polymer is from about 40 kDa to about 75 kDa.

Aspect 213. The method of Aspect 200, wherein weight average molecular weight of the first polymer is from about 40 kDa to about 70 kDa.

Aspect 214. The method of any one of Aspect 163-Aspect 213, wherein weight average molecular weight of the second polymer is from about 20 kDa to about 100 kDa.

Aspect 215. The method of Aspect 214, wherein weight average molecular weight of the second polymer is from about 25 kDa to about 95 kDa.

Aspect 216. The method of Aspect 214, wherein weight average molecular weight of the second polymer is from about 30 kDa to about 90 kDa.

Aspect 217. The method of Aspect 214, wherein weight average molecular weight of the second polymer is from about 35 kDa to about 85 kDa.

Aspect 218. The method of Aspect 214, wherein weight average molecular weight of the second polymer is from about 40 kDa to about 75 kDa.

Aspect 219. The method of Aspect 214, wherein weight average molecular weight of the second polymer is from about 45 kDa to about 70 kDa.

Aspect 220. The method of Aspect 214, wherein weight average molecular weight of the second polymer is from about 30 kDa to about 85 kDa.

Aspect 221. The method of Aspect 214, wherein weight average molecular weight of the second polymer is from about 30 kDa to about 80 kDa.

Aspect 222. The method of Aspect 214, wherein weight average molecular weight of the second polymer is from about 30 kDa to about 75 kDa.

Aspect 223. The method of Aspect 214, wherein weight average molecular weight of the second polymer is from about 30 kDa to about 70 kDa.

Aspect 224. The method of Aspect 214, wherein weight average molecular weight of the second polymer is from about 40 kDa to about 85 kDa.

Aspect 225. The method of Aspect 214, wherein weight average molecular weight of the second polymer is from about 40 kDa to about 80 kDa.

Aspect 226. The method of Aspect 214, wherein weight average molecular weight of the second polymer is from about 40 kDa to about 75 kDa.

Aspect 227. The method of Aspect 214, wherein weight average molecular weight of the second polymer is from about 40 kDa to about 70 kDa.

Aspect 228. The method of any one of Aspect 163-Aspect 227, wherein the dispersity is from about 1 to about 5.

Aspect 229. The method of Aspect 228, wherein the dispersity is from about 1.5 to about 4.5.

Aspect 230. The method of Aspect 228, wherein the dispersity is from about 1.5 to about 4.

Aspect 231. The method of Aspect 228, wherein the dispersity is from about 2 to about 4.

Aspect 232. The method of Aspect 228, wherein the dispersity is from about 2.5 to about 4.

Aspect 233. The method of Aspect 228, wherein the dispersity is from about 3 to about 4.

Aspect 234. The method of Aspect 228, wherein the dispersity is from about 2 to about 5.

Aspect 235. The method of Aspect 228, wherein the dispersity is from about 2 to about 4.5.

Aspect 236. The method of Aspect 228, wherein the dispersity is from about 2 to about 3.5.

Aspect 237. The method of Aspect 228, wherein the dispersity is from about 2 to about 3.

Aspect 238. The method of any one of Aspect 163-Aspect 237, wherein the dispersity of the second polymer is from about 1 to about 5.

Aspect 239. The method of Aspect 238, wherein the dispersity of the second polymer is from about 1.5 to about 4.5.

Aspect 240. The method of Aspect 238, wherein the dispersity of the second polymer is from about 1.5 to about 4.

Aspect 241. The method of Aspect 238, wherein the dispersity of the second polymer is from about 2 to about 4.

Aspect 242. The method of Aspect 238, wherein the dispersity of the second polymer is from about 2.5 to about 4.

Aspect 243. The method of Aspect 238, wherein the dispersity of the second polymer is from about 3 to about 4.

Aspect 244. The method of Aspect 238, wherein the dispersity of the second polymer is from about 2 to about 5.

Aspect 245. The method of Aspect 238, wherein the dispersity of the second polymer is from about 2 to about 4.5.

Aspect 246. The method of Aspect 238, wherein the dispersity of the second polymer is from about 2 to about 3.5.

Aspect 247. The method of Aspect 238, wherein the dispersity of the second polymer is from about 2 to about 3.

Aspect 248. The method of any one of Aspect 163-Aspect 247, wherein the cross-linker is present in the swelling solution at a concentration of from about 0.1 mg/mL to about 5 mg/mL.

Aspect 249. The method of Aspect 248, wherein the cross-linker is present in the swelling solution at a concentration of from about 0.1 mg/mL to about 4 mg/mL.

Aspect 250. The method of Aspect 248, wherein the cross-linker is present in the swelling solution at a concentration of from about 0.1 mg/mL to about 3 mg/mL.

Aspect 251. The method of Aspect 248, wherein the cross-linker is present in the swelling solution at a concentration of from about 0.1 mg/mL to about 2 mg/mL.

Aspect 252. The method of Aspect 248, wherein the cross-linker is present in the swelling solution at a concentration of from about 0.1 mg/mL to about 1 mg/mL.

Aspect 253. The method of Aspect 248, wherein the cross-linker is present in the swelling solution at a concentration of from about 0.2 mg/mL to about 2 mg/mL.

Aspect 254. The method of Aspect 248, wherein the cross-linker is present in the swelling solution at a concentration of from about 0.3 mg/mL to about 1.9 mg/mL.

Aspect 255. The method of Aspect 248, wherein the cross-linker is present in the swelling solution at a concentration of from about 0.4 mg/mL to about 1.8 mg/mL.

Aspect 256. The method of Aspect 248, wherein the cross-linker is present in the swelling solution at a concentration of from about 0.5 mg/mL to about 1.7 mg/mL.

Aspect 257. The method of Aspect 248, wherein the cross-linker is present in the swelling solution at a concentration of from about 0.5 mg/mL to about 1.6 mg/mL.

Aspect 258. The method of Aspect 248, wherein the cross-linker is present in the swelling solution at a concentration of from about 0.5 mg/mL to about 1.5 mg/mL.

Aspect 259. The method of Aspect 248, wherein the cross-linker is present in the swelling solution at a concentration of from about 0.8 mg/mL to about 1.2 mg/mL.

Aspect 260. The method of any one of Aspect 163-Aspect 259, wherein the initiator comprises NaH.

Aspect 261. The method of any one of Aspect 163-Aspect 260, wherein pre-swelling the pre-crosslinked membrane with a swelling solution comprising a cross-linker and a first organic solvent is carried out at a temperature from about 15° C. to about 30° C. for a period from about 1 hour to about 48 hours.

Aspect 262. The method of any one of Aspect 163-Aspect 261, wherein initiating a cross-linking reaction in the swollen pre-crosslinked membrane by adding an initiator in a second organic solvent thereto is carried out at a temperature from about 15° C. to about 30° C. for a period from about 1 hour to about 48 hours.

Aspect 263. A battery, fuel cell, or separation device comprising a cross-linked permeable membrane made by the method of any one of Aspect 163-Aspect 262.

Aspect 264. The battery of Aspect 263, wherein the battery is a redox flow battery.

Aspect 265. The battery of Aspect 263, wherein the redox flow battery is a non-aqueous redox flow battery.

Aspect 266. A redox flow battery comprising: comprising a cross-linked permeable membrane made by the method of any one of Aspect 163-Aspect 262; a positive electrode; a positive electrolyte comprising a first redox active composition, wherein the positive electrolyte is in contact with the positive electrode; a negative electrode; and a negative electrolyte comprising a second redox active composition, wherein the negative electrode is in contact with the negative electrode, and wherein the cross-linked blended membrane is interposed between the positive electrode and the negative electrode.

Aspect 267. The redox flow battery of Aspect 266, wherein the redox flow battery is a non-aqueous redox flow battery.

Aspect 268. The redox flow battery of Aspect 266 or Aspect 267, wherein the positive electrode and the negative electrode independently comprise a metal, a carbon material, an electro-conductive polymer, and combinations thereof.

Aspect 269. The redox flow battery of any one of Aspect 266-Aspect 268, wherein the positive electrolyte and the negative electrolyte each comprise a solvent independently selected from the group consisting of acetonitrile, dimethylacetamide, diethyl carbonate, dimethyl carbonate, γ-butyrolactone, propylene carbonate, ethylene carbonate, N-methyl-2-pyrrolidone, fluoroethylene carbonate, N, N-dimethylacetamide, and combinations thereof.

Aspect 270. The redox flow battery of Aspect 269, wherein the positive electrolyte and the negative electrolyte each comprise the same solvent.

Aspect 271. The redox flow battery of Aspect 269 or Aspect 270, wherein the positive electrolyte and the negative electrolyte each comprise a solvent independently selected from the group consisting of acetonitrile, dimethylacetamide, diethyl carbonate, dimethyl carbonate, and combinations thereof.

Aspect 272. The redox flow battery of Aspect 271, wherein the solvent is dimethyl carbonate.

Aspect 273. The redox flow battery of any one of Aspect 266-Aspect 272, wherein the positive electrolyte and/or the negative electrolyte comprise an electrolyte salt selected from the group consisting of lithium bis(fluorosulfonyl)imide, lithium tetrafluoroborate, lithium hexafluorophosphate, lithium perchlorate, lithium methyltrifluoromethanesulfonate, lithium bis(trifluoromethylsulfonyl)imide, tetraethyl ammonium tetrafluoroborate, tetrabutyl ammonium tetrafluoroborate, and combinations thereof.

Aspect 274. The redox flow battery of any one of Aspect 266-Aspect 273, wherein the first and/or second redox active compositions comprise a metallocene.

Aspect 275. The redox flow battery of Aspect 274, wherein the metallocene is a ferrocene.

Aspect 276. An energy storage system comprising the redox flow battery of Aspect 266, or a stack comprising a plurality thereof.

Aspect 277. The energy storage system of Aspect 276, wherein the energy storage system is connected to an electrical grid.

Aspect 278. A method of storing energy, the method comprising connecting the energy storage system of Aspect 277 to an electrical grid.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### H. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Example 1: Methods

### Overall Membrane Preparation Strategy

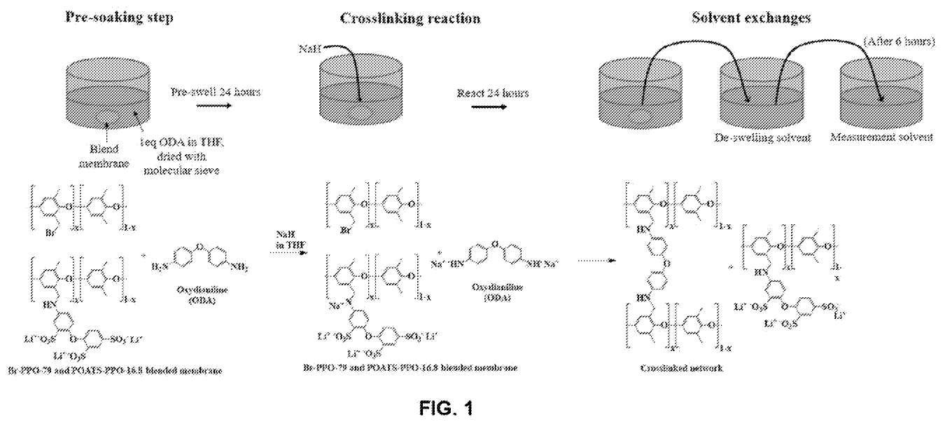

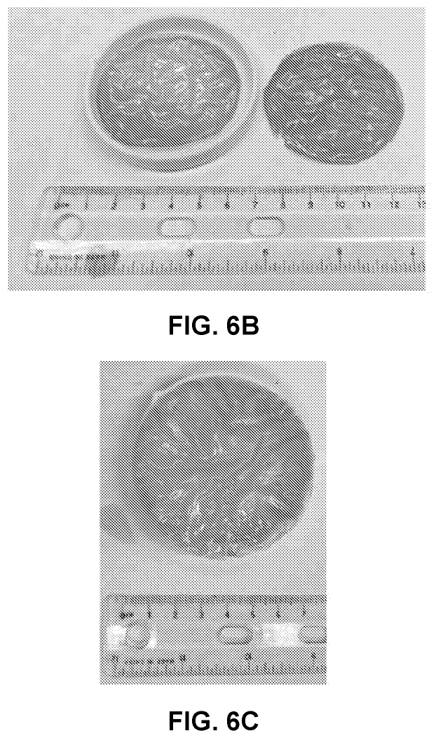

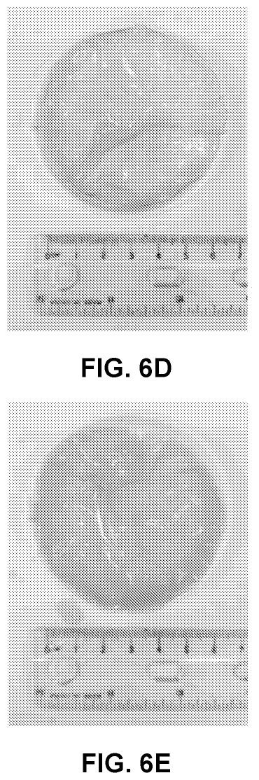

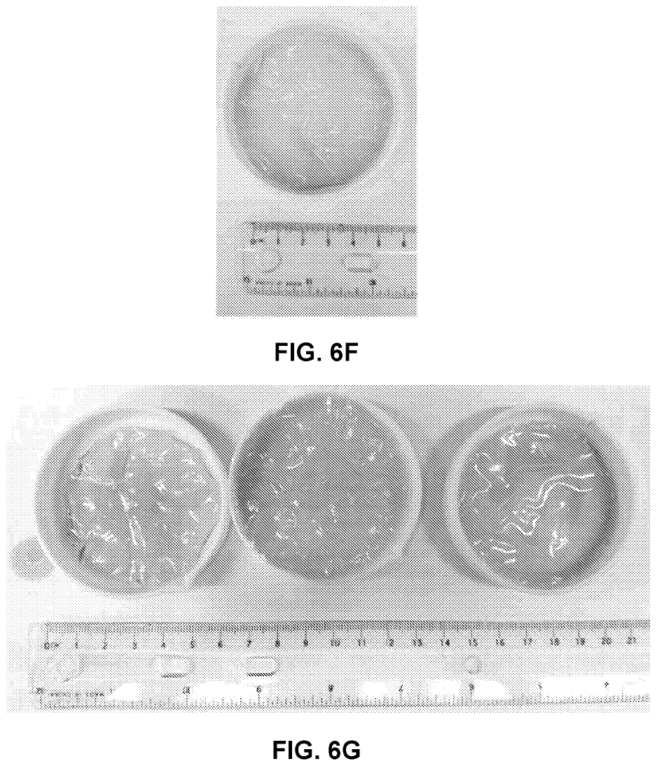

Crosslinked membranes were formed by blending brominated poly(phenylene oxide) (Br-PPO) with the ion exchange polymer phenoxyaniline trisulfonate-substituted PPO (POATS-PPO) prior to film casting. Then, a bifunctional molecule (oxydianiline, ODA), which reacts with Br-PPO, was added to crosslink the blend membrane without forming a fixed charge group (FIG. 1). Photographs of the cast crosslinked membranes at different stages of the crosslinking process are shown in FIGS. 6A-6G.

Crosslinking was performed while the cast membranes were swollen in tetrahydrofuran, THF, (˜150% uptake by mass). Swelling in THF was necessary to allow ODA to diffuse into the membrane and to permit the subsequent reaction between ODA and the bromine functional group on Br-PPO. Following the crosslinking reaction between ODA and Br-PPO, the membranes were not allowed to dry. Rather, the THF was removed by exchanging it with a different solvent, called the de-swelling solvent. In this study, the de-swelling solvent was either water, ethanol, or acetonitrile (ACN).

The solvent exchange process following crosslinking was designed to take advantage of effects similar to membrane casting by phase inversion with a nonsolvent. In the phase inversion casting process, a support coated with polymer dissolved in solution is immersed quickly in a nonsolvent for the polymer, and mixing of the solvent and nonsolvent causes the polymer to come out of solution and solidify rapidly. The specific nonsolvent used can affect the final membrane morphology by changing how quickly the precipitation and solvent exchange steps occur, and it was hypothesized that similar morphological or structural differences could be achieved by swelling the polymer to a large extent (i.e., ˜150% using THF), then quickly replacing the strongly swelling THF with one of the less strongly swelling de-swelling solvents.

The de-swelling process led to tunable property differences in the membranes that persisted even after the de-swelling solvent was replaced yet again with a measurement solvent, which was selected from a range of suitable solvents used in nonaqueous flow batteries: dimethyl carbonate (DMC), propylene carbonate (PC), or ACN. Measured membrane physical and electrochemical properties depended on both the de-swelling solvent history and the measurement solvent used for characterization. Membranes were referred to by the solvents used in these two exchanges. For example, a membrane that was prepared using ethanol as the de-swelling solvent and characterized using DMC as the measurement solvent was be referred to as an ethanol/DMC membrane.

### Br-PPO Synthesis

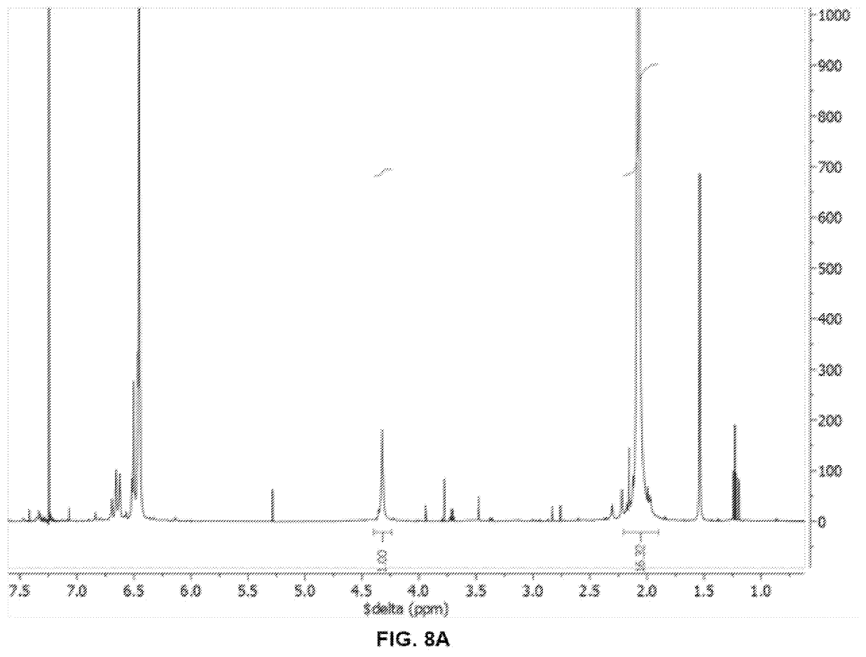

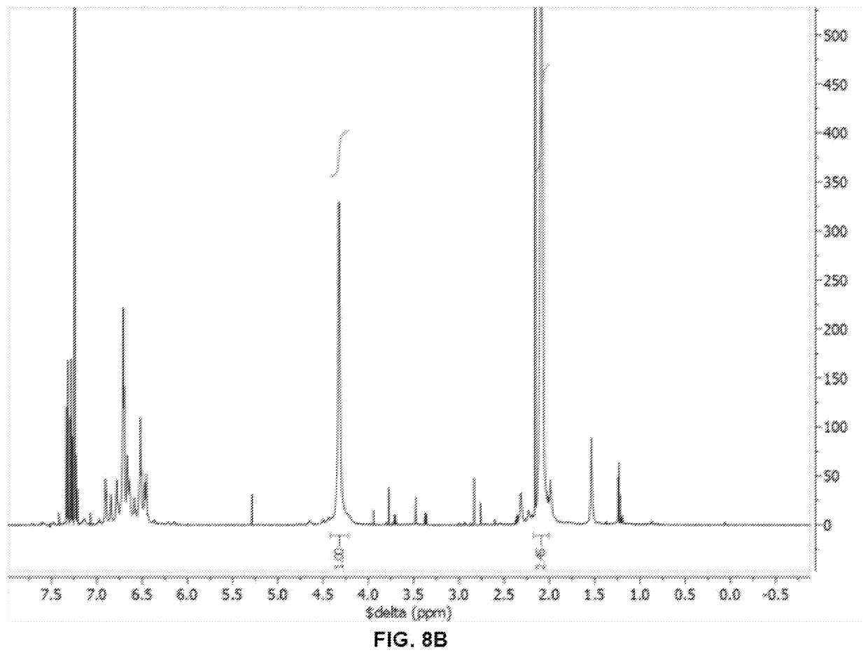

Br-PPO was synthesized via a free radical bromination reaction of poly(phenylene oxide), PPO (Sigma-Aldrich). The amounts of the bromine source (N-bromo-succinimide, NBS, >98%, TCI Chemicals) and free radical initiator (azobisisobutyronitrile, AIBN, 98%, Sigma-Aldrich), relative to PPO, were varied to obtain different degrees of bromination. In this work, Br-PPO with bromine substitution of 16.6% at the benzyl position of PPO repeat units was used for producing POATS-PPO, and Br-PPO with a bromine substitution of 79% was used for crosslinking, measured by 1H NMR FIGS. 8A-8B); these materials were referred to as Br-PPO-16.6 and Br-PPO-79.23 Preparation of both materials began by dissolving 6 g of PPO in 75 mL of chlorobenzene and heating in a 110° C. oil bath. For Br-PPO-16.6, a total of 3.2 g of NBS and 0.179 g of AIBN were pre-weighed, evenly distributed into 4 glass vials, and stirred to mix the powders. This amount of NBS could theoretically result in Br-PPO-36, so the yield of this substitution was approximately 46%. For the Br-PPO-79, a total of 10.0 g of NBS and 0.561 g of AIBN were used, and divided into 4 glass vials in the same way. This amount of NBS could theoretically result in Br-PPO-112, so the yield of this substitution was approximately 71%. Each vial of mixed NBS and AIBN powder was then added to the reaction flask containing the PPO solution, at intervals of 15 min between each addition. Sequential addition of NBS and AIBN over the course of 45 min, when preparing highly brominated Br-PPO, limited Br₂ formation and reduced undesired bromination at the aromatic positions. The reaction proceeded at 110° C. for 30 min after the last NBS and AIBN addition (total reaction time of 75 min), and the product was collected by precipitating the reaction mixture in 10-fold excess reagent alcohol. The polymer was collected by filtration and dried under vacuum to remove the alcohol. A second purification was performed by dissolving the polymer in 50 mL of chloroform and repeating the precipitation in reagent alcohol followed by filtration and drying.

### Phenoxyaniline Trisulfonate (POATS) Synthesis

POATS was synthesized using an aromatic sulfonation of 4-phenoxyaniline, reported previously.23 Briefly, 2 g of 4-phenoxyaniline was dissolved in 15 mL of 20% fuming sulfuric acid, under stirring in an ice bath. Then, over the course of 30 min, the reaction temperature was raised to 80° C. and held at that temperature for 2 h. To end the reaction, the mixture was poured slowly over ice made from deionized (DI, 18.2 MΩ cm, Direct-Q 3 UV, Millipore) water and then was diluted, with DI water, to a total volume of 500 mL. Triethylamine (TEA) was added in an equimolar amount with regard to the theoretical number of aromatic sulfonate groups (4.5 mL of TEA in this example). Then, calcium carbonate was added to neutralize the remaining sulfuric acid (typically ˜30 g). The precipitated calcium sulfate was filtered out, and the collected liquid solution was dried in a rotary evaporator at 70° C. The remainder of the calcium sulfate was removed by dissolving the TEA⁺ counter-ion form POATS in 15 mL of DI water and filtering out the undissolved solids. The POATS solution was then dried first in an oven at 80° C. for 16 h and then under vacuum at room temperature for an additional 24 h. The yield of TEA⁺ counter-ion form POATS was approximately 76%.

### POATS-PPO Synthesis

POATS-PPO was produced using an updated procedure, relative to previous reports, which resulted in better yields at higher degrees of substitution. To limit water contamination, all reactants and glassware were dried under room-temperature vacuum for 24 h prior to reaction, and all solvents were stored over 3 Å molecular sieve for a minimum of 48 h before use. In an example procedure, 0.6 g of Br-PPO-16.6 was dissolved in a mixture of 4 mL of NMP and 4 mL of chlorobenzene, and 1.09 g of POATS (2 equiv, relative to the moles of Br) was dissolved separately in 16 mL of NMP. The two solutions were added to a stirred reaction flask that contained 250 mg NaHCO₃. The mixture was heated in a 60° C. oil bath for 24 h and then precipitated in 300 ml of isopropyl alcohol. The suspension was centrifuged, and the liquid was decanted. The solid product was washed first with an aqueous solution containing 0.1 M HCl and 0.11 M TEA, to ensure the amine groups in the product were deprotonated and the sulfonate groups were in the TEA counter-ion form, and then washed with DI water to remove free salt. The solid product was isolated after each washing step via centrifugation and decantation. Finally, the POATS-PPO product was dried under vacuum for 24 h before further use.

### Crosslinked Membrane Synthesis

Reactive bromine groups were required for the crosslinking reaction. The POATS substitution of Br-PPO to form POATS-PPO, however, proceeded to completion. To provide bromine groups for the crosslinking procedure, POATS-PPO-16.6 and Br-PPO-79 solutions were mixed together and cast to form a blend membrane.

To prepare a typical membrane, 0.167 g of POATS-PPO-16.6 and 0.033 g of Br-PPO-79 were dissolved together in 2 mL of DMF. This degree of bromination and polymer mass ratio leads to a theoretical maximum crosslink density of 0.43 mmol crosslinks g⁻¹. The blend membrane was cast by pouring this solution into 6 cm diameter PTFE molds, and the polymer was dried first in an 80° C. convection oven for 4 h and subsequently in an 80° C. vacuum oven for 24 h. After drying, the sulfonate groups in the blend membranes were converted to the Li⁺ counter-ion form by soaking the films in a 0.5 M lithium chloride solution for 8 h. The solution was replaced with fresh solution following the first 4 h of soaking. Finally, the film was soaked in DI water for 2 h and then dried under vacuum at room temperature for 24 h. A typical final membrane prepared via this route was approximately 60 μm thick and had a mass of 0.16 g, due to mass losses from transferring and casting the viscous polymer solution and from conversion from the TEA⁺ (102 g mol-1) counter-ion form to the much lighter Li⁺ (7 g mol⁻¹) counter-ion form.

Bromine sites on the Br-PPO in the blend membrane were used to crosslink the material using ODA as the crosslinker. The procedure began by pre-swelling and removing trace water from the blend membrane by soaking the film in a solution of 1 mg mL⁻¹ ODA in THF that was mixed with 2 g of 4 Å molecular sieve powder in a glass jar that allowed the membrane to lay flat for 24 h. The volume used in this initial procedure was chosen to achieve an equimolar match of the ODA amine groups and the Br groups present in the blend membrane, e.g., 13.8 mL of ODA in THE solution for a 0.16 g blend membrane.

The crosslinking reaction was initiated by adding 0.1 g of 60% NaH in mineral oil to the soaking solution, and the mixture was allowed to react for 24 h at room temperature. The reaction was quenched by removing the membrane from the solution and quickly transferring it to a de-swelling solvent: water, ethanol, or ACN. The membranes were soaked in the de-swelling solvent for 6 h to remove THF from the membrane.

Finally, the membranes were moved to the measurement solvent: DMC, PC, or ACN. This solvent was replaced once after 24 h to minimize the amount of de-swelling solvent present in the final membrane. The final membrane thickness, while swollen in measurement solvent, increased slightly relative to the non-cross-linked membranes, where membranes de-swelled in water and measured in PC had the highest average final thickness (75 μm). Membrane samples were stored in the measurement solvent until use, and this use of three de-swelling solvents and three measurement solvents resulted in a matrix of nine membrane processing conditions that were subsequently characterized.

### Membrane Solvent Uptake and Solvent Volume Fraction

Solvent uptake was measured by removing the crosslinked membranes from the measurement solvent, quickly wiping the surface to remove excess liquid, and weighing the membrane to determine the solvated mass. Membrane pieces were then dried for 24 h at room temperature under vacuum (for DMC and ACN measurement solvents) or 72 h at 80° C. under vacuum (for PC measurement solvent), and the sample dry (i.e., effectively solvent-free) mass was determined. To ensure the membranes were fully dried (i.e., solvent was effectively removed), samples were returned to the vacuum chamber for an additional 24 h after which their mass was unchanged. Solvent uptake, SU, was calculated as

$$SU = 100 \% \times \frac{solvatd mass - dry mass}{dry mass}$$

Solvent uptake was converted to solvent volume fraction, ¢, using dry membrane and solvent densities and by assuming volume additivity

$$Φ = \frac{SU}{SU - \frac{{ρ}_{solvent}}{{ρ}_{polymer}}}$$

where ρₛₒₗᵥₑₙₜ is the density of the measurement solvent (Table 1) and ρ_{polymer} was taken as the density of the dry non-crosslinked blend membrane. It was assumed that the density of the polymer did not change appreciably after crosslinking (since ODA was chemically very similar to the chemistry of the rest of the polymer), and the dry density was measured to be 1.38 g mL⁻¹ via the procedure described subsequently.

TABLE 1
Electrolyte Solvent Properties

| | | | | | | 4-hydroxy- |
|---|---|---|---|---|---|---|
| | | | | | Ferrocene | TEMPO |
| | | | | Conductivity | Solution | Solution |
| | Viscosity | Dielectric | Density | of 1M LiFSI | Diffusivity | Diffusivity |
| Solvent | (cP) | Constant | (g/mL) | (mS/cm)^{a} | (cm²/s)^{b} | (cm²/s)^{b} |
| Propylene | 2.52 | 64.9 | 1.20 | 6.7 | 4.93 × 10⁻⁶ | 4.46 × 10⁻⁶ |
| carbonate | | | | | | |
| Dimethyl | 0.59 | 3.1 | 1.06 | 6.9 | 2.00 × 10⁻⁵ | 1.80 × 10⁻⁵ |
| carbonate | | | | | | |
| Acetonitrile | 0.34 | 35.9 | 0.79 | 37 | 2.33 × 10⁻⁵ | 2.11 × 10⁻⁵ |

^{a}Measured with conductivity probe at 20° C.
^{b}Calculated using the Wilke-Chang correlation.

Polymer dry density was measured using an Archimedes' principle method. The mass of the dry non-crosslinked blend membrane was measured in air while the membrane was submerged in cyclohexane. The blend membrane sorbed a negligible amount of cyclohexane over the timescale of the experiment. With the membrane masses measured in air and cyclohexane (mₐᵢᵣ and m_{cyclohexane}, respectively) and the known densities of air and cyclohexane (ρₐᵢᵣ and ρ_{cyclohexane}, respectively) at the measurement temperature, dry membrane density, ρ_{polymer}, was calculated as

$${ρ}_{polymer} = \frac{{m}_{air}}{{m}_{air} - {m}_{cyclohexane}} ( {ρ}_{cyclohexane} - {ρ}_{air} ) - {ρ}_{air}$$

### Ion Exchange Capacity (IEC)

The fixed charge density of the polymer was quantified as the IEC, which was reported as milli-equivalents of sulfonate groups per gram of dry (i.e., effectively solvent-free) polymer (mequiv g⁻¹). To measure the IEC of the membrane via a titration method, samples were soaked in 0.5 M HCl for 24 h at room temperature to convert the fixed charge groups from the Li⁺ counter-ion form to the acid (H⁺) counter-ion form. Samples were then moved to DI water, which was replaced three times and allowed to soak for 1 h each time.

The secondary amines formed during the addition of POATS and ODA molecules to the Br-PPO can act as a base during the acid-soaking process. Therefore, this initial step of the IEC measurement process may have resulted in more uptake of acidic protons than is required to replace completely the Li⁺ counter-ions with H⁺ counter-ions because of acid-base chemistry that can occur with the secondary amines that connect the crosslinker and side chain to the polymer backbone. Additional acid uptake via this process would interfere with the IEC measurement. To ensure that the secondary amines in the polymer were deprotonated, the pH of the last DI water-soaking solution was measured and verified to be above pH 6.

Following the DI water-soaking step, the membranes were moved to a 0.1 M CaCl₂ solution for 24 h at room temperature to convert the sulfonate groups to the calcium counter-ion form and release the protons into solution. This solution was then titrated with 0.01 M NaOH to measure the amount of H⁺ released by the membrane during the ion exchange process to the calcium counter-ion form. The final pH of this solution (after soaking) was typically around 3, so some of the acid released from the sulfonate groups could have been absorbed by protonation of the secondary amine groups in the membrane and thus not be accounted for during the titration. To account for this retained acid, the membrane was left to soak in the neutralized solution (following the first titration) for 24 h. Subsequently, the solution was titrated a second time to measure the additional acid released from the secondary amines in the material. The membranes were then dried in an 80° C. vacuum oven for 24 h, and the dry mass was measured. The IEC was calculated as

$$IEC [ mequiv {g}^{- 1} ] = \frac{{V}_{0.01 M NaOH} \times 10 mM}{{m}_{dry}}$$

where the total volume of titration solution (from both titrations), V0.01M NaOH (L), and the membrane dry mass, m_{dry} (g).

### Ionic Conductivity

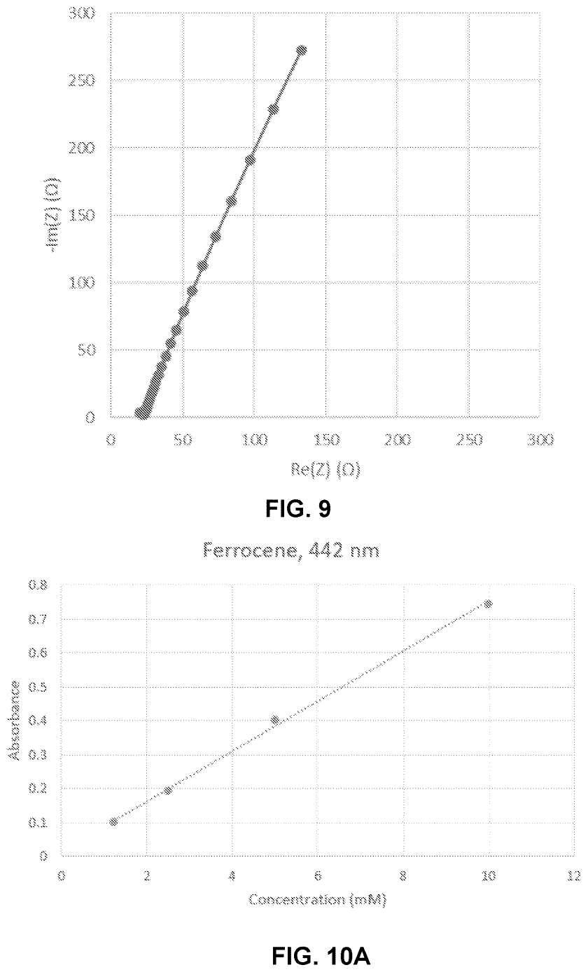

Ionic conductivity was measured using through-plane electrochemical impedance spectroscopy (EIS). Membranes soaked in DMC, PC, or ACN measurement solvents were cut into 0.75-inch diameter circles and moved to a 1.0 M LiFSI solution made using the same measurement solvent (either DMC, PC, or ACN solvent, respectively). Membranes were placed in a BioLogic controlled environment sample holder (CESH), with 0.5-inch diameter circular electrodes. Impedance was measured using a potentiostat (BioLogic SP-300) to impose an oscillating potential with a 20 mV amplitude over a frequency range of 1 MHz to 100 Hz, an example spectrum can be found in FIG. 9. The resulting data were fit to a model circuit, and the high-frequency intercept with the real impedance axis was used to determine the membrane resistance. This intercept resistance also included the cell resistance, and the cell resistance was measured (with no membrane present in the cell) and subtracted from the value obtained when the membrane was loaded in the cell to determine the membrane resistance, R (in Ω). Cell resistance was low compared to membrane resistance values (typically 0.5Ω for the cell compared to 10-50Ω for the membranes). Following the EIS measurement, membranes were removed from the sample holder, and sample thickness was measured in three places and averaged. Resistance was converted to ionic conductivity, σ, as

$$σ [ mS {cm}^{- 1} ] = 1000 ( \frac{1}{RA} )$$

where I is the average sample thickness in cm and A is the area of the electrodes, 1.27 cm². Membranes evaluated were always larger than the electrode area.

### Permeability

Permeability was measured using a glass H-cell. The cell was assembled with a membrane (pre-soaked in DMC, PC, or ACN measurement solvent) separating the two halves of the cell. One half of the cell contained 0.1 M active material (either ferrocene or 4-hydroxy-TEMPO) in the same measurement solvent used to pre-soak the membrane, and the other half of the cell (i.e., the blank side) initially contained pure measurement solvent. The active material concentration of the solution in the blank side of the cell, which increased as active material permeated through the membrane, was measured three times using UV-vis spectroscopy.

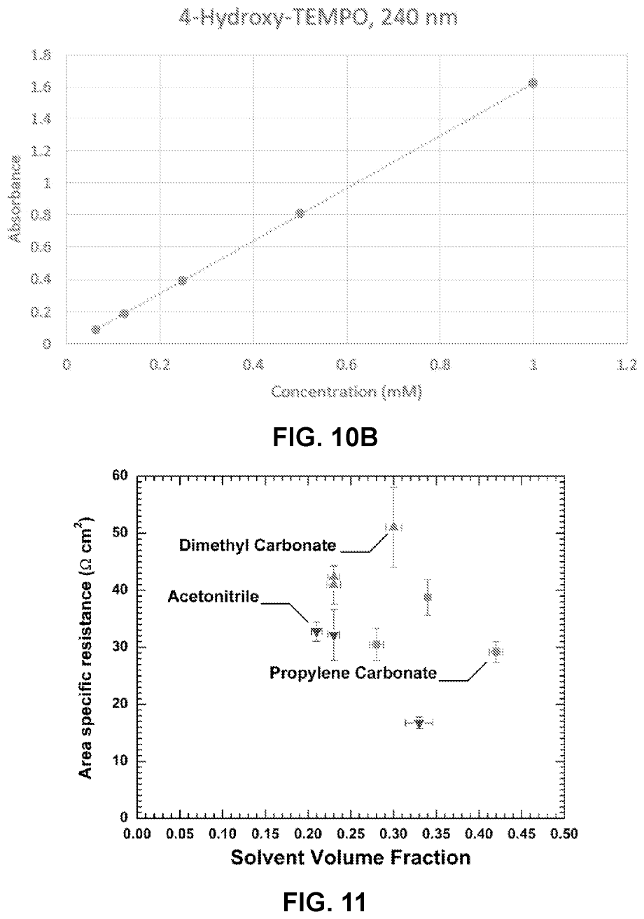

The measurement frequency was chosen based on the rate of crossover so that all three measurements would be within the calibration range of the UV-vis measurement technique and roughly evenly spaced in time. Calibration curves and concentration ranges for ferrocene and 4-hydroxy-TEMPO can be found in FIGS. 10A-10B. In this report, the highest permeability values were measured using a 2 h measurement interval, and the lowest permeability values were measured with a 10-day measurement interval. After the last measurement, the cell was disassembled, and the thickness of the sample was measured. The permeability was calculated as

$${P}_{t} = \frac{{V}_{L} l}{2 A} ln ( 1 - 2 \frac{{C}_{R} [ t ]}{{C}_{D} [ t ]} )$$

where P is permeability in cm² s⁻¹, V_{L} is the volume on each side of the membrane in mL, I is the membrane thickness in cm, A is the cross-sectional area of the membrane exposed to solution in cm², C_{R}[t] is the measured active material concentration of the solution in the blank side of the cell at time t, and C_{D}[0] is the initial active material concentration (0.1 M) of the solution on the other side of the membrane.

### 2. Example 2: Results and Discussion

### Measurement Solvent Uptake

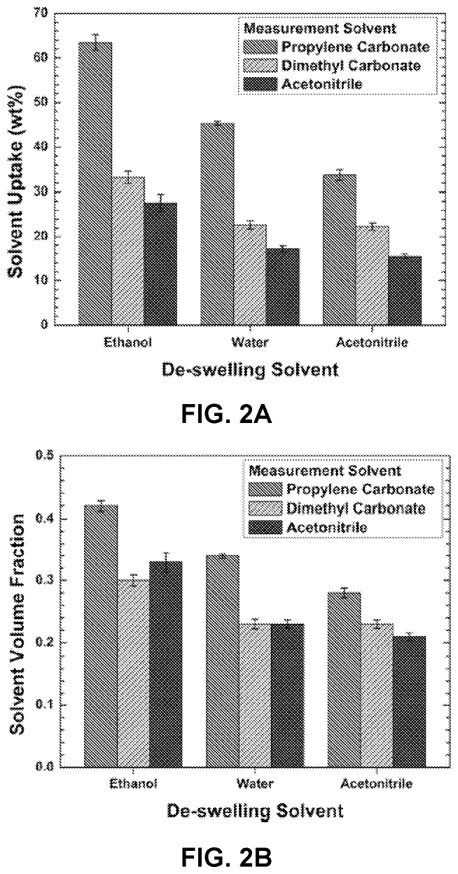

A series of crosslinked membranes with varied solvent uptakes were produced via two solvent exchange steps. First, a de-swelling solvent exchange step removed the highly swelling THF reaction solvent. Next, the de-swelling solvent was replaced, via a second exchange, with the measurement solvent that was used for transport property evaluation: PC, DMC, or ACN. The measurement solvents were chosen because they can be used as electrolyte solvents in RFBs. Cyclic and linear carbonates, including PC and DMC, have been studied extensively as lithium-ion battery electrolytes, and ACN is popular as a nonaqueous RFB electrolyte due to its high ionic conductivity and low viscosity. These measurement solvents also have different physical properties, e.g., viscosity and dielectric constant, which could affect how they solvate the membranes. The relevant physical and electrochemical properties of the solvents, electrolytes, and active material solutions are shown in Table 1. The differences in solvent uptake created by the de-swelling solvent persisted after the de-swelling solvent was replaced by the measurement solvent (FIG. 2A). In general, the ethanol de-swelling solvent resulted in the highest uptake values followed by water and ACN, which tended to have similar uptakes by comparison. This trend was the same as the solvent uptake trend of the three de-swelling solvents in non-crosslinked membranes (in the absence of solvent exchange steps) with solvent weight uptakes of 50, 26, and 20% for ethanol, water, and ACN, respectively. Within each specific de-swelling solvent, the measurement solvent PC led to the highest uptake, whereas ACN (in its role as a measurement solvent) resulted in the lowest uptake. Notably, the solvent weight uptake of ACN de-swelled membranes, with ACN as the measurement solvent, had a lower solvent weight uptake than the non-crosslinked membrane ACN uptake (15 vs 20%). This result suggested that either the crosslinking procedure lowered equilibrium uptake, or the solvent exchange process caused the polymer morphology to change to a lower solvent uptake configuration.

The solvent exchange process from THF to the de-swelling solvent resulted in visible differences in the membrane that were de-swelling solvent-specific (photographs in FIGS. 6A-6G). Solvent exchange from THE to ACN shrank the membrane to approximately its original size before the THF swelling process. Exchange from THF to either water or ethanol had much less of an influence on membrane swelling, and the resulting membranes had a larger diameter than both the ACN de-swelled membrane and the membrane diameter before exposure to THF.

Solvent volume fraction was also considered because the measurement solvents had different densities and transport properties often correlate strongly with solvent volume fraction, as opposed to mass fraction. Solvent volume fraction generally mirrored the qualitative solvent uptake results (FIG. 2B) and to some extent attenuated differences between the de-swelling and measurement solvent effects.

The sensitivity of uptake and swelling results to solvent history may be a result of the glassy nature of the PPO backbone. The de-swelling solvent may establish a chain configuration that was then locked into place by the kinetically trapped nature of the glassy polymer chains. Similar solvent-based effects have been leveraged in commercial membrane applications, though many of these details are often regarded as industrial art.

Both the de-swelling and measurement solvents affected the final solvent volume fraction of the membrane, and the de-swelling solvent most significantly influenced the volume fraction of PC in the membrane. Membrane swelling was not as strongly influenced by the use of either DMC or ACN as the measurement solvent, but the use of ethanol as the de-swelling solvent did lead to higher measurement solvent uptakes compared to the other two de-swelling solvents.

The higher measured solvent volume fraction of PC compared to DMC and ACN may be due to differences in how the charged regions of the polymer interact with the measurement solvent. PC had a higher dielectric constant than either DMC or ACN (Table 1), which may have led to stronger solvation of the charged sulfonate groups of POATS. Although the Li⁺ counter-ion form of POATS was not significantly soluble in any of these solvents, the TEA⁺ counter-ion form of POATS was soluble in PC, while it was not soluble in ACN or DMC. This observation further suggested a greater affinity between POATS and PC compared to POATS and either DMC or ACN, which could have resulted in the observed higher solvent uptakes.

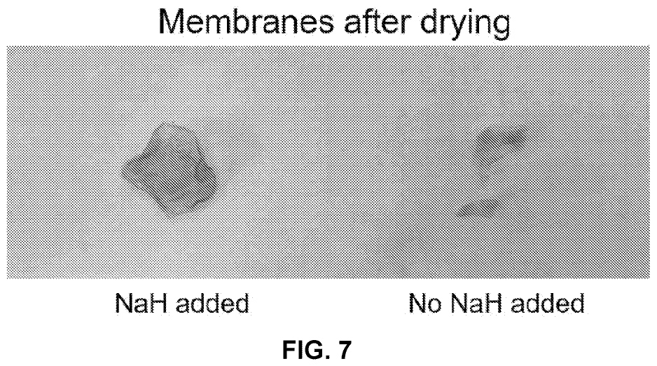

The crosslinking and solvent exchange procedures represent changes to POATS-PPO processing relative to previous reports. To provide evidence of the critical role of the crosslinking step, materials were also prepared without adding NaH to investigate the effects of the solvent exchange process without crosslinking the membranes. However, the non-crosslinked membranes could not withstand the stress created by the de-swelling process, and they did not remain intact (FIG. 7). Membrane IECs were also measured before and after crosslinking, and the IEC was unchanged by the procedure (2.5 mequiv g⁻¹) suggesting no charge group degradation. These control experiments, and consideration of other possible side reactions, are discussed in more detail below.

### Ionic Conductivity

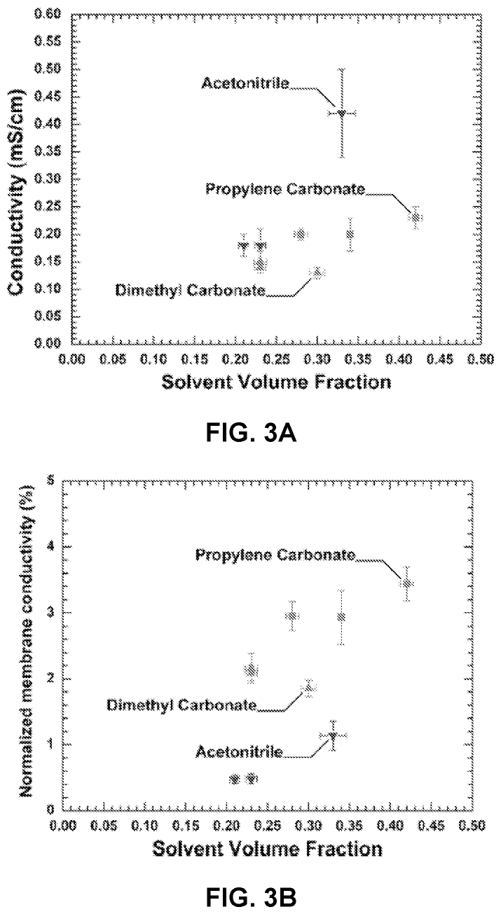

Membrane ionic conductivity was measured using 1.0 M LiFSI electrolytes in each of the measurement solvents (FIG. 3A) because of the high solution conductivity and good stability of LiFSI and the measured area specific resistance values are also reported in FIG. 11. The POATS-PPO material contained a high concentration of Li⁺ charge carriers, with an IEC of 2.5 mequiv g⁻¹, and such materials often have high cation transference numbers. As such, ionic conduction in POATS-PPO was assumed to result primarily from migration of Li⁺. The ionic conductivity of membranes soaked in electrolytes prepared using both carbonate solvents was relatively independent of solvent volume fraction, with the DMC values specifically not having a statistically significant difference. Membranes measured in ACN had a more significant dependence on solvent volume fraction, where the ethanol/ACN membranes specifically had a higher membrane conductivity than the other membranes measured using the ACN electrolyte. The solution conductivity of the ACN electrolyte was higher than that of either carbonate electrolyte (Table 1), so the membrane conductivity may have been more sensitive to ACN electrolyte uptake.

Direct correlation between solvent uptake and conductivity has previously been observed, but solvent uptake typically changes as a result of another change to the system, such as the membrane IEC or electrolyte composition. In the present study, changes in solvent uptake were imposed by the use of different de-swelling and measurement solvents. Previous POATS-PPO results showed an increase in conductivity from 0.015 to 0.061 mS cm⁻¹ as solvent uptake increased from 31 to 39%. This change likely was driven by an increase in IEC from 0.75 to 1.17 mequiv g⁻¹, and was a larger relative change in conductivity than was observed using any measurement solvent in FIG. 3. Not all reports in the literature show as strong a dependence of conductivity on solvent uptake as these examples, even in systems where solvent uptake was increased by increasing the IEC. In one report, conductivity changed from 0.14 to 0.34 mS cm⁻¹ with a solvent uptake change from 12 to 26%, and another report showed a conductivity change from just 0.08 to 0.11 mS cm⁻¹ with a thickness ratio change from 2 to 11%, where both of these reports also had changes to IEC.

The dependence of conductivity on solvent uptake appears to be solvent or polymer specific. In ACN, the conductivity more than doubled (comparing the lowest solvent volume fraction to the highest), but with PC and DMC, no statistically significant change was observed. Similar solvent-specific behavior has been observed in Nafion-like membranes, i.e., polymers with the same structure as Nafion, but different equivalent weights (i.e., IEC values). Generally, Nafion conductivity increases with solvent uptake when the uptake changes as a result of changing the solvent, but data of this type in the literature has been reported with a large amount of scatter. The solvent uptake alternatively can be varied by changing the equivalent weight of the material, and these changes had large impacts on conductivity for some solvents, but in other solvents, the changes in conductivity with changing solvent uptake were less pronounced.

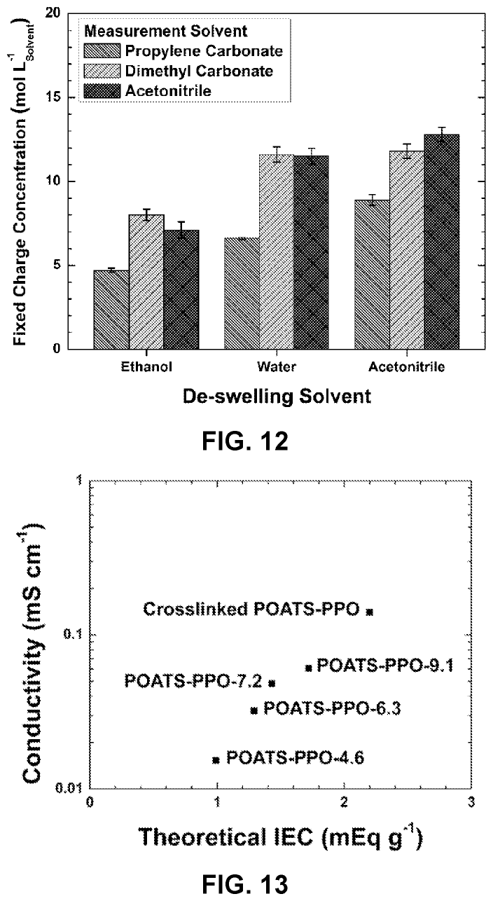

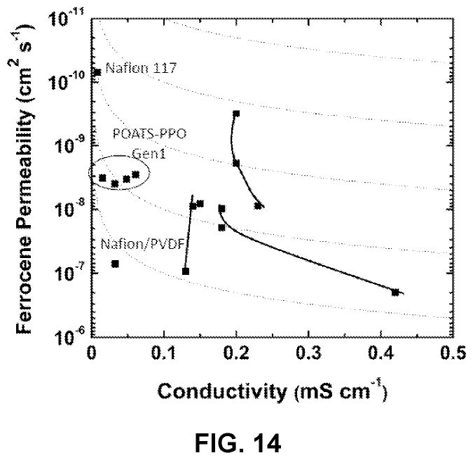

For example, comparing 1200 g equiv⁻¹ (IEC=0.83 mequiv g⁻¹) and 800 g equiv⁻¹ (IEC=1.25 mequiv g⁻¹) Nafion, the water uptake of these membranes increased from 25 to 380% uptake, respectively, and PC uptake also increased significantly from 30 to 175% uptake as the IEC increased. Despite the increase in water uptake, the Li⁺ conductivity of the two water-soaked membranes was nearly identical, but in the PC-soaked membranes, the Li⁺ conductivity of the 0.83 mequiv g⁻¹ membrane was approximately 30 times lower than the 1.25 mequiv g⁻¹ membrane. In both cases, changes in equivalent weight (IEC) resulted in different uptake properties, but in water, those changes did not affect ionic conductivity, whereas they did in PC. The increased solvent uptake of the higher IEC membranes results in a lower charge density, due to increased membrane volume. This decrease in fixed charge density appears to have different impacts on the membrane conductivity depending on the measurement solvent, i.e., conductivity in PC is more affected than conductivity in water. The fixed charge density of the crosslinked membranes reported can be found in FIG. 12. These differences could be a result of differences in ion solvation by the different solvents. Studies of Li-ion battery electrolytes have shown that PC, DMC, and ACN have different ion solvation characteristics, i.e., the fraction of ions that exist as free ions, solvent-separated ion pairs, or contact ion pairs changed depending on solvent, salt, and concentration. These differences in the ion pairing and solvation characteristics may lead to differences in sensitivity to charged group spacing. Thus, the solvent-specific relationship between conductivity and solvent uptake may be related to the physical fixed charge group spacing in the membranes and the specific mechanism of charge transport and solvation in each solvent.

Solvent-specific effects can be investigated further by considering the bulk electrolyte conductivity of the different measurement solvents (Table 1). The membrane ionic conductivity data were normalized by the conductivity of bulk 1.0 M LiFSI electrolyte in each of the measurement solvents (FIG. 3B). Normalization in this manner attempted to account for differences in conductivity that were intrinsic to a specific solvent, and it emphasized the extent to which the polymer impeded the conduction process. FIG. 3B shows that the polymer environment leads to dramatically reduced ionic conductivity (by at least 96%) relative to that of the bulk electrolyte for all of the measurement solvents considered.

The high ionic conductivity of POATS-PPO observed when using the ACN measurement solvent (FIG. 3A) was speculated to result largely from the high ionic conductivity of 1.0 M LiFSI in ACN (as opposed to in PC or DMC) (Table 1). The data in FIG. 3B, however, suggest that interactions between LiFSI, ACN, and the polymer act to restrict conduction in a manner that overcomes the highly conductive nature of LiFSI in ACN relative to the other two measurement solvents. Alternatively, specific polymer/measurement solvent interactions reduced conductivity to a lesser extent when PC was used as opposed to the other two measurement solvents. Ultimately, the data in FIGS. 3A-3B suggest that the inherent conductivity of LiFSI in the measurement solvents was insufficient to explain the ionic conductivity of the membrane. Rather, solvent-specific effects appear to play an important role.

One solvent-specific property that could result in these observations is the dielectric constant since it is often related to the ability of a solvent to dissociate a salt, necessary for ionic conductivity. Of the three measurement solvents, PC had the highest dielectric constant (Table 1), and the ratio of membrane conductivity to solution conductivity was greatest when PC was used (FIG. 3B). However, DMC had the lowest dielectric constant but not the lowest ratio of membrane conductivity to solution conductivity. This behavior has also been noted in bulk electrolytes of LiPF6 in mixtures of ethylene carbonate (EC) and DMC, where despite the difference in dielectric constant (90 vs 3.1), both EC and DMC participate in ion solvation. An explanation for the ion solvation properties observed while using DMC (given its low dielectric constant compared to other common electrolyte solvents) is the change in conformation of the methyl groups of the DMC molecule. Although the more stable cis-cis conformation of DMC has a low dielectric constant, MD simulations have suggested that coordination with Li⁺ stabilizes the much more polar cis-trans conformer, which causes an increase in the dipole moment from 0.34 to 3.76. This stabilization and resulting change in the dipole moment likely increases the DMC dielectric constant in the environment near ions relative to bulk property measurements. As a result, the ability of DMC to solvate ions in the membrane may be higher than the dielectric constant suggested in Table 1, and this difference could help to promote Li⁺ conduction in the membrane when DMC is used as the measurement solvent.

Even with high dielectric constant solvents like PC, dissociation of fixed charge groups in the polymer may be low. The Li⁺ counter-ion form of POATS was not particularly soluble (<1 mg mL⁻¹) in DMC, PC, or ACN, and this observation suggested that dissociation of the POATS sulfonate groups was not favorable in these solvents. Other work has demonstrated that polymer charge groups which more easily dissociate in nonaqueous solvents, i.e., trifluoromethanesulfonylimide, led to higher membrane ionic conductivity than an equivalent membrane with sulfonate groups.

This observation was also consistent with Nafion data; reported conductivities in PC, DMC, and ACN were all several orders of magnitude below bulk solution conductivities, suggesting the low Li⁺ conductivity in these solvents compared to the ionic conductivity of the bulk electrolyte solution was not specific to POATS-PPO-based membranes. 19 Other nonaqueous membrane conductivity studies have suggested that the ability of fixed charge groups to dissociate in the nonaqueous solvent may be the rate-limiting step for ionic conduction. In these studies, the use of Li⁺ complexing agents in solution improved charge group dissociation and membrane conductivity increased up to 2 orders of magnitude above membranes soaked in solutions without additives. All together, these results imply that the ion dissociation in the polymer phase is low and may be limiting the conductivity of the membrane. Although the measured IEC of these crosslinked membranes was high (2.5 mequiv g⁻¹), a low degree of dissociation would result in a low concentration of mobile charges in the membranes and could lead to the observed low fractions of solution conductivity in FIG. 3B.

### Dissolved Active Material Permeability

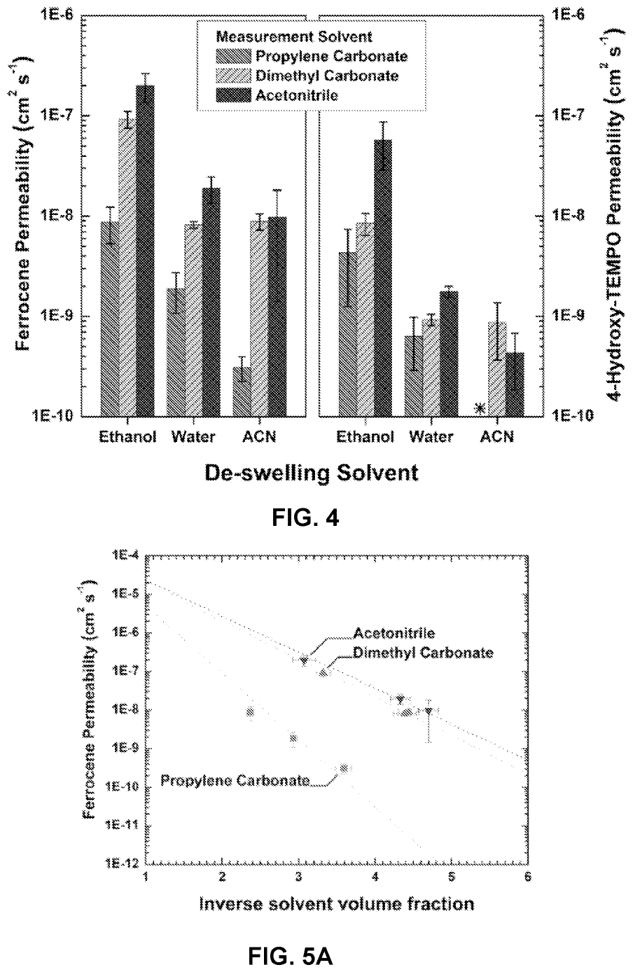

RFB membranes need to resist active material crossover to prevent capacity fade as the battery cycles. Ferrocene and 4-hydroxy-TEMPO were used as representative active materials because they have been used in nonaqueous RFBs; these compounds had different thermodynamic interactions with the backbone polymer and different permeability through POATS-PPO membranes. Permeability properties describe the tendency of the membrane to permit or block active material crossover. Ferrocene and 4-hydroxy-TEMPO permeability properties for the crosslinked membranes are reported in FIG. 4.

In general, ferrocene permeability was greater than that of 4-hydroxy-TEMPO, which was consistent with previous reports, but the use of different de-swelling solvents (and the resulting differences in solvent uptake) appeared to affect the magnitude of this difference. For example, the ratios of ferrocene permeability to 4-hydroxy-TEMPO permeability for high swelling membranes (i.e., membranes made using ethanol as the de-swelling solvent) were 2.0, 1.8, and 3.4 for PC, DMC, and ACN measurement solvents, respectively. In membranes that swell to a lesser extent (i.e., membranes made using ACN as the de-swelling solvent), the ratios increased in all cases, but to different extents: ≥31.1, 6.5, and 22.6 for PC, DMC, and ACN measurement solvents, respectively. This difference in selectivity was consistent with a general trade-off relationship between permeability and selectivity that has been previously observed in other systems, where more permeable membranes tend to be less selective. In this case, the change in selectivity was different for each measurement solvent, but this may be because the change in solvent uptake from ACN de-swelled membranes to the ethanol de-swelled membranes was also different for each measurement solvent.

In general, higher uptake of a given measurement solvent resulted in higher permeability for both active materials. This trend was expected as permeability often correlates strongly with solvent uptake. However, this general relationship would also lead one to expect that permeability values would be highest when PC was used as the measurement solvent since the PC measurement solvent led to higher solvent uptake compared to DMC or ACN (FIG. 2A). Comparison of FIG. 2A and FIG. 4 revealed that the opposite was true. Ferrocene and 4-hydroxy-TEMPO permeability values were lower when PC was used as the measurement solvent compared to the cases where either ACN or DMC measurement solvents were used even though solvent uptake was greatest when PC was used as the measurement solvent.

This unexpected result may be additional evidence that the higher solvent volume fraction observed with the PC measurement solvent was due to the preferential solvation of the charged regions of the polymer. A previous study found that uncharged active material permeation may occur primarily in the uncharged, PPO backbone-rich, regions of POATS-PPO.34 Additionally, changing the IEC of the membrane had a negligible influence on uncharged molecule permeability despite changes in solvent uptake. Together, these results suggested that solvent uptake which occurs preferentially in the charged regions of the polymer may have a smaller effect on uncharged molecule permeability properties compared to changes in the solvent uptake of the uncharged regions of the polymer. The conductivity as a fraction of solution conductivity was also higher when PC (as opposed to DMC or ACN) was the measurement solvent (FIG. 3B), and this observation could also be explained by preferential PC solvation of the charged regions of POATS-PPO compared to the other measurement solvents.

The permeability property differences between the three measurement solvents may be investigated in more detail using a free volume-based description of transport. In an extension of the model originally developed by Yasuda et al. (based on the work of Cohen and Turnbull), the permeability, P, can be related to the volume fraction of solvent in the polymer, Φ, as

$$P = {P}_{0} exp [ - \frac{B}{Φ} ]$$

where P₀ and B are taken as constants. These constants are related to several factors, where P₀ is a constant related to the solution diffusivity and sorption coefficient, and B is related to the proportionality constant between membrane solvent uptake and free volume available for transport and the permeant size, or, more specifically, the minimum free volume element size required for the permeating molecule to execute a diffusion step. Therefore, permeability data correlated with 1/Φ can provide insight into membrane structural factors that may be sensitive to the use of different measurement solvents.

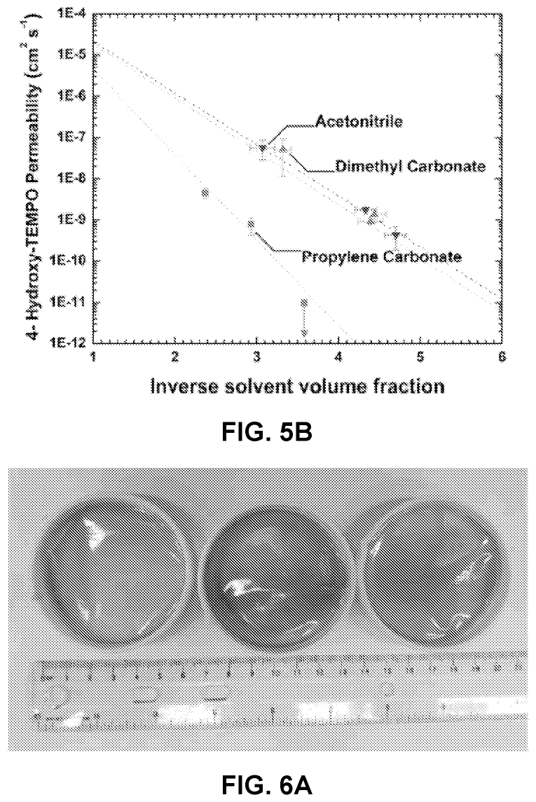

The relationship between permeability and solvent volume fraction is shown as permeability vs the inverse of the solvent volume fraction in FIGS. 5A-5B. At an inverse solvent volume fraction of 1, the trend line should pass through the point equivalent to the diffusion coefficient of the molecule in bulk solution (Table 1), on the vertical axis. This requirement was because the product of the diffusion coefficient of the molecule in bulk solution and the partition coefficient for bulk solution (equal to unity) was the effective permeability of the bulk solution, which corresponded to Φ=1.44 In FIGS. 5A-5B, the trend lines were constrained to pass through the diffusion coefficient of the molecule in bulk solution (Table 1) when Φ=1, and the slope was determined via linear regression.

The intercept of the trend line for the PC measurement solvent at Φ=1 was lower than the intercepts for the DMC or ACN measurement solvent trend lines in a manner consistent with the diffusion coefficients of the molecules in bulk solution (Table 1). These differences stemmed from differences in solution viscosity; PC had a significantly higher viscosity than DMC or ACN (2.52 vs 0.59 cP and 0.34 cP, respectively, Table 1) meaning that diffusion in PC was slower compared to DMC or ACN. Additionally, although ferrocene had a slightly higher molecular weight than 4-hydroxy-TEMPO (186 vs 172 g mol⁻¹), the ferrocene molar volume was slightly smaller (123 vs 145 mL mol⁻¹) than that of 4-hydroxy-TEMPO. As a result, ferrocene diffusion coefficients in bulk solution were slightly greater compared to the situation for 4-hydroxy-TEMPO.

When ACN and DMC measurement solvents were used, permeability properties and the slopes of the best fit lines for both were similar for both ferrocene and 4-hydroxy-TEMPO. This result suggested that the solvated sizes of ferrocene and 4-hydroxy-TEMPO may be similar in the ACN or DMC solvents. Additionally, it suggested that the ACN and DMC solvents interacted with and impacted the polymer network similarly. This result was unexpected given the differences between ACN and DMC. ACN and DMC have different molecular weight and dielectric constant properties that might lead to differences in the size of the solvation shell of ferrocene or 4-hydroxy-TEMPO, and therefore differences in the minimum free volume element size required for diffusion (i.e., the slope of the trend lines in FIGS. 5A-5B).

While the trend line slopes for both ferrocene and 4-hydroxy-TEMPO were similar when ACN and DMC were used as a measurement solvent, the trend lines when PC was used as the measurement solvent were steeper than ACN and DMC in both cases. To some extent, the lower permeability values may result from bulk solution properties (i.e., the diffusivity of ferrocene and 4-hydroxy-TEMPO in PC was slower than that in ACN or DMC). However, the steeper slope of the trend line for the PC measurement solvent data compared to that for the ACN or DMC measurement solvents suggested that larger free volume elements were needed for ferrocene and 4-hydroxy-TEMPO to execute diffusional jumps in the membrane when PC was used as opposed to ACN or DMC, which could be the result of differences in solvation of either the active materials and/or the polymer.

Combining the permeability and conductivity results, these membranes had more favorable combinations of transport properties than Nafion in the same solvents. Comparisons of the data presented here to literature reports of Nafion are shown in Table 2. Overall, compared to the crosslinked POATS-PPO membranes, Nafion has low conductivity for lithium ions in the solvents used in this study. When measured in PC, the ACN de-swelled crosslinked membrane showed improved properties over Nafion, achieving both an order of magnitude higher conductivity and two orders of magnitude lower ferrocene permeability. The crosslinked membranes also had significantly higher conductivity than Nafion 117 in DMC and ACN, but the ferrocene permeability in ACN was similar for the crosslinked membranes and Nafion. In DMC, Nafion had much lower ferrocene permeability than the crosslinked membranes. Notably, there were crosslinked membranes with comparable solvent uptake to Nafion for all three measurement solvents, but in all solvents, the Nafion appeared to have more restricted transport, i.e., lower conductivity and similar or lower permeability at the same solvent uptake.

TABLE 2
Tabulated Data for the Crosslinked POATS-PPO along with Nafion Data for Comparison

| | | | | Lithium | | 4-hydroxy |
|---|---|---|---|---|---|---|
| | | | Solvent | ion | Ferrocene | TEMPO |
| | Deswelling | Measurement | Uptake | conductivity | permeability | permeability |
| Membrane | solvent | Solvent | (%) | (mS/cm) | (cm²/s) | (cm²/s) |
| Crosslinked | Ethanol | Propylene | 63.5 | 0.23 | 8.8 × 10⁻⁹ | 4.6 × 10⁻⁹ |
| POATS- | | carbonate | | | | |
| PPO | Water | Propylene | 45.3 | 0.20 | 1.9 × 10⁻⁹ | 7.8 × 10⁻¹⁰ |
| | | carbonate | | | | |
| | Acetonitrile | Propylene | 33.7 | 0.20 | 3.1 × 10⁻¹⁰ | <1.0 × 10⁻¹¹ |
| | | carbonate | | | | |
| | Ethanol | Dimethyl | 33.2 | 0.13 | 9.3 × 10⁻⁸ | 5.2 × 10⁻⁸ |
| | | carbonate | | | | |
| | Water | Dimethyl | 22.8 | 0.15 | 8.2 × 10⁻⁹ | 9.3 × 10⁻¹⁰ |
| | | carbonate | | | | |
| | Acetonitrile | Dimethyl | 22.4 | 0.14 | 8.9 × 10⁻⁹ | 1.4 × 10⁻⁹ |
| | | carbonate | | | | |
| | Ethanol | Acetonitrile | 27.6 | 0.42 | 2.0 × 10⁻⁷ | 5.8 × 10⁻⁸ |
| | Water | Acetonitrile | 17.2 | 0.18 | 1.9 × 10⁻⁸ | 1.8 × 10⁻⁹ |
| | Acetonitrile | Acetonitrile | 15.4 | 0.18 | 9.8 × 10⁻⁹ | 4.4 × 10⁻¹⁰ |
| Nafion 117 | N/A | Propylene | 65 | 0.02 | 3 × 10⁻⁸ | N/A |
| | | carbonate | | | | |
| | N/A | Dimethyl | 23 | 0.008 | <1 × 10⁻¹¹ | N/A |
| | | carbonate | | | | |
| | N/A | Acetonitrile | 19 | 0.005 | 9.6 × 10⁻⁹ | N/A |

Finally, although these crosslinked membranes have a much different synthesis procedure and composition than previously reported versions of POATS-PPO membranes, they continue to follow many trends that were noted in previous work. Ferrocene permeability continued to be independent of IEC for these crosslinked membranes, and the relation between IEC and the log of conductivity remains linear for the crosslinked membranes.

### Conclusions

A crosslinking method for a sulfonated, PPO-based polymer was developed using an uncharged crosslinker and post-crosslinking solvent exchange steps to vary solvent uptake without significantly changing the membrane composition. The combination of crosslinking and solvent exchange steps revealed membrane properties that depended on both the specific de-swelling solvent used to prepare the membrane, which impacted solvent uptake, and the measurement solvent used to characterize the material.

Ionic conductivity was highest when ACN was used to characterize the membranes (up to 0.42 mS cm⁻¹), and this result was likely due to the significantly higher bulk solution conductivity of LiFSI in ACN compared to that in PC or DMC. The ionic conductivity and active material permeability were affected by both the de-swelling and measurement solvents, although with different trends for each solvent. Interestingly, free volume analysis suggested that the effective free volume element size required for transport was greater when PC was used as the measurement solvent compared to that for DMC and ACN. This observation suggested differences in the way that PC solvates the active materials and/or the polymer.

In this system, due to the differing dependence of conductivity and permeability on solvent uptake, membranes measured in PC had the most favorable combination of conductivity (0.20 mS cm⁻¹) and permeability (4-hydroxy-TEMPO, <10⁻¹¹ cm² s⁻¹). However, considering different redox shuttles, or the other impacts of using PC as the electrolyte solvent on the battery, could result in another solvent having the best overall performance in an RFB system. Also, since these effects appear to be a result of the specific interactions of PC with the membrane, these favorable material properties may be sensitive to the specific chemical composition of the polymer.

The solvent-specific effects reported in this work could be leveraged to prepare more effective membranes. Compared to prior versions of POATS-PPO, the membranes reported here achieved a higher fixed charge density (i.e., IEC) with more favorable mechanical properties and a combination of conductivity and permeability properties that was more desirable for RFB applications. The trends and observations reported here suggest that solvent-specific behavior will be critical for engineering membrane separators for nonaqueous redox flow battery applications.

### 3. Example 3: Additional Experiments

### Membrane Processing

Photographs of the membranes at different stages of the process (i.e., a cast triethylammonium (TEA⁺) counter-ion form membrane, a membrane converted to the Li⁺ counter-ion form, a membrane soaked in THE following the crosslinking reaction, and membranes that had been de-swelled in each of the three de-swelling solvents) are provided in FIGS. 6A-6G. Conversion from the TEA⁺ to Li⁺ counter-ion form caused the membranes to shrink slightly (FIGS. 6A-6B). Soaking in THF caused the membranes to increase in size (FIG. 6C), and this increase in size resulted in membranes that were larger than the original molds used to cast the membranes (solvent weight uptake was approximately 150%). De-swelling with ACN caused the membranes to return to roughly the mold size, but membranes de-swelled with ethanol and water remained slightly larger than the mold size (FIGS. 6D-6F).

After 6 hours of soaking in the de-swelling solvent, the membranes were moved to a measurement solvent, either PC, DMC, or ACN. After this solvent exchange to the measurement solvent, membranes that had been de-swelled in water and acetonitrile shrunk to a similar size as the Li⁺ counter-ion form membrane, but the membranes that had been de-swelled in ethanol remained larger than the mold size (FIG. 6G). Additionally, the membranes de-swelled using water were slightly cloudy (although this was not easily visible in photographs taken, it was clear to the naked eye), but the other two membranes were not. This cloudy appearance disappeared, however, after solvent exchange to any of the measurement solvents.

Membrane samples were also produced using the procedure described above without adding NaH. This modification to the procedure resulted in membranes that were not crosslinked. These membranes were mechanically very weak and did not remain intact during the de-swelling process (FIG. 7). Therefore, it was not possible to reliably measure their conductivity or permeability properties.

### UV/VIS Calibration

Ultraviolet/Visible (UV/Vis) spectroscopy was used to measure the concentration of ferrocene and 4-hydroxy-TEMPO for the permeability experiments. The analysis was limited to concentrations bound by a lower detection limit and an upper detector saturation limit. Ferrocene could be measured in the range of 1 mM to 10 mM using an absorbance peak at 442 nm, and the calibration curve (with DMC as the solvent) is shown in FIG. S5a. 4-hydroxy-TEMPO could be measured in the range of 0.1 mM to 1 mM using an absorbance peak at 240 nm, and the calibration curve (with DMC as the solvent) is shown in FIG. 10B. Measurable concentration ranges were the same for all solvents considered.

### Estimation of Diffusivity in Solution

Diffusion coefficients for ferrocene and 4-hydroxy-TEMPO were estimated in PC, DMC, and ACN solvents using the Wilke-Chang correlation:

$${D}_{0} = 7.4 \times {10}^{- 8} \frac{{TM}^{1 / 2}}{η {v}^{0.6}}$$

where T is the temperature in Kelvin, M is the molar mass of the solvent in g mol⁻¹, η is the solution viscosity in cP, and V is the solute molar volume in mL mol⁻¹. Ferrocene and 4-hydroxy-TEMPO molar volumes were calculated from molar mass and solid density properties. The values and sources of the input data for solvents and solutes are shown in Tables 3 and 4, respectively. The results of the calculations are shown in Table 1. Some experimentally measured diffusion coefficients have been reported in the literature, and these values were consistent with estimated values: 4.1×10⁻⁶ cm² s⁻¹ measured vs. 4.9×10⁻⁶ cm² s⁻¹ estimated in propylene carbonate and 2.5×10⁻⁵ cm² s⁻¹ measured vs. 2.3×10⁻⁵ cm² s⁻¹ estimated in acetonitrile for ferrocene. For consistency, diffusion coefficients estimated using the Wilke-Chang correlation were used even when experimental values were available.

TABLE 3
Solvent Properties Used for the Wilke-Chang Correlation Estimates

| Solvent | Molar Mass (g/mol) | Viscosity (cP) |
|---|---|---|
| Propylene carbonate | 102.1 | 2.52 |
| Dimethyl carbonate | 90.1 | 0.59 |
| Acetonitrile | 41.1 | 0.34 |

TABLE 4
Active Material Properties Used for
the Wilke-Chang Correlation Estimates

| | Density | Molar | Molar |
|---|---|---|---|
| Active Material | (g/mL) | Mass (g/mol) | Volume (mL/mol) |
| Ferrocene | 1.49 | 186.4 | 123 |
| 4-hydroxy-TEMPO | 1.19 | 172.2 | 145 |

TABLE 5
Diffusion Coefficients (D₀) for Each Active Material
in Each of the Three Measurement Solvents Estimated
Using the Wilke-Chang Correlation

D₀ (cm²/s)

| | Propylene | Dimethyl | |
|---|---|---|---|
| Active Material | carbonate | carbonate | Acetonitrile |
| Ferrocene | 4.9 × 10⁻⁶ | 2.0 × 10⁻⁵ | 2.3 × 10⁻⁵ |
| 4-hydroxy-TEMPO | 4.5 × 10⁻⁶ | 1.8 × 10⁻⁵ | 2.1 × 10⁻⁵ |

### Possibility of Fixed Charge Group Degradation or Side Reactions During Crosslinking

To investigate if fixed charge group degradation occurred in the membranes as a result of the crosslinking conditions, the IEC values before and after the reaction were compared. The crosslinking reaction should not result in the addition or removal of fixed charged groups, so a change in IEC during the crosslinking step would indicate fixed charge group degradation under the strongly basic crosslinking reaction conditions. Degradation could occur during the reaction with NaH, but the nature of the de-swelling solvent would not be expected to impact the IEC of the material. Therefore, the IEC of membranes made with only one de-swelling solvent, water, was measured. Similarly, since solvent exchange or soaking in the measurement solvent was not expected to cause degradation, and since the IEC measurement required the membrane to be soaked in water, the crosslinked membrane was measured without exchanging the solvent to any measurement solvent and back to water.

The results of these experiments did not suggest charge group or broader polymer degradation during crosslinking; IEC measured before the crosslinking reaction was 2.6±0.2 meq g⁻¹ and IEC after was 2.52±0.06 meq g⁻¹, where the uncertainty was the standard deviation of three measurements. These values were higher than the theoretical IEC, 2.2 meq g⁻¹. This outcome suggested that some of the aniline groups present in the membrane were still protonated when the titration occurred. Although unsubstituted aniline has a pKa of 4.87, which should be fully dissociated at neutral pH, the substituents may have increased the pKa of these groups so that it was not fully in the deprotonated form. If all aniline groups that were part of the POATS molecule were protonated, the theoretical measured IEC would be 2.79 meq g⁻¹, or if the Br-PPO fully reacted with ODA and all aniline groups from both POATS and ODA were protonated before the titration, the theoretical measured IEC would be 3.66 meq g⁻¹. The measured IEC was between the values for no aniline group protonation and full protonation, which suggested partial protonation of the aniline groups. However, since the IEC was unchanged from before and after the reaction, the amount of charge group degradation was likely negligible.

It is noted with these crosslinked membranes that the secondary amine connection between POATS and PPO may also be able to participate in the crosslinking reaction. However, this secondary amine connection is less mobile, because it is attached to the undissolved polymer, and is more sterically hindered than the —NH₂ group present on the ODA. Additionally, this reaction would still result in a crosslink forming, so the presence and relative amount of this reaction was not quantified.

### Membrane Area Specific Resistance (ASR)

The ASR values for each membrane are shown in FIG. 11. The thickness of membranes generally increased as measurement solvent uptake increased, which led to different trends in the ASR vs. solvent volume fraction plot than in the plot of conductivity vs. solvent volume fraction (FIGS. 3A-3B). For example, the ASR of membranes measured in DMC increased with solvent volume fraction, despite constant conductivity values. With ACN as the measurement solvent, the more significant increase in membrane conductivity with solvent volume fraction caused this trend to reverse, and the ASR decreased with increasing solvent volume fraction. Crosslinked membranes in PC measurement solvent had more variable thickness, leading to a non-monotonic trend in FIG. 11.

### Fixed Charge Density

The concentration of charged groups in a membrane is affected by the solvent uptake, since increased swelling leads to greater separation of charge groups. Fixed charge concentration, expressed in moles of charged groups per L of sorbed measurement solvent takes this effect into account (FIG. 12). The data in FIG. 12 were calculated as:

$$Fixed charge concentration = \frac{IEC \times SU}{{ρ}_{solvent}}$$

### Comparisons to Previous Work

It is noted that the POATS-PPO material used in this study had a higher fixed charge density (i.e., concentration of sulfonate groups or IEC) compared to previous work. This higher fixed charge density was achieved because the crosslinking procedure reported here provided sufficient improvement in mechanical integrity to prepare a higher fixed charge density material than had been previously accessible without crosslinking. Therefore, it was important to consider how the increased fixed charge density of these crosslinked materials affected conductivity and permeability properties relative to previously reported POATS-PPO membranes.

Our previous study found that ferrocene permeability did not depend significantly on fixed charge density. Importantly, this prior result appeared to continue to be true for the higher fixed charge density crosslinked membranes considered in the present study (even for the lowest solvent uptake ACN de-swelling solvent membranes). For example, “POATS-PPO-7” from the prior study had a ferrocene permeability of 1.2×10⁻⁸ cm² s⁻¹ and a 4-hydroxy-TEMPO permeability of 1.1×10⁻⁹ cm² s⁻¹ in DMC. In the present report, the ferrocene and 4-hydroxy-TEMPO permeability values of the membrane prepared using ACN as the de-swelling solvent and DMC as the measurement solvent were 8.9×10⁻⁹ cm² s⁻¹ and 8.7×10⁻¹⁰ cm² s⁻¹. The differences in permeability for the two membrane materials (both from the prior study and in the present study with crosslinking) using DMC as solvent was not statistically significant (p>0.05). This outcome was consistent with thermodynamic analysis suggesting that ferrocene and 4-hydroxy-TEMPO preferentially permeate through backbone (or PPO) rich regions of the polymer.

Importantly, in contrast to the relatively constant permeability outcomes, the ionic conductivity continued to increase as the fixed charge density increased. The ionic conductivity achieved exceeded the values obtained previously, in a continuation of a trend previously reported for POATS-PPO. For example, the membrane prepared using ACN as the de-swelling solvent had an ionic conductivity of 0.14 mS cm⁻¹ in 1.0 M LiFSI in DMC (FIGS. 3A-3B). POATS-PPO-9.1 from a previous study, with an IEC of 1.2 meq g⁻¹ compared to 2.5 meq g⁻¹ in this work, had an ionic conductivity of 0.061 mS cm⁻¹ while immersed in the same electrolyte. This result also was consistent with results of a previous study, suggesting that increasing fixed charge density drove an increase in ionic conductivity without a significant change in permeability. Interestingly, on a plot of the log of conductivity vs. IEC the crosslinked membranes continue the linear trend from the prior report with non-crosslinked membranes, FIG. 13. In this plot the previous membrane conductivity was only measured in DMC, so only DMC measurement solvent data is shown for crosslinked membranes.

The ratio of conductivity to permeability has been used as a measure of selectivity or figure of merit for RFB performance.8,10 Of the materials reported in this study, this ratio of conductivity to permeability was maximized by the use of ACN as the de-swelling solvent, PC as the measurement solvent, and 4-hydroxy-TEMPO as the redox active material. The significantly lower permeability values for membranes characterized using PC compared to DMC and ACN, with relatively similar ionic conductivity, would be beneficial for RFBs. The fundamental underpinnings of the solvent-specific effects reported in this work were outside of the scope of this report, but understanding these factors will be important for rationally controlling and improving membrane properties for non-aqueous RFBs.

This knowledge is particularly important because the choice of solvent and active material will likely be influenced by other RFB requirements or engineering factors beyond the properties considered in this work (e.g., battery voltage, electrochemical stability, active material solubility, cost, etc.). The PC solvent, for example, has the highest viscosity and lowest solution conductivity of the measurement solvents used here, which will influence the energy required to pump the electrolyte and the ionic overpotential in the electrodes. Even though the membrane characterized using the PC measurement solvent realized the best figure of merit properties, the use of PC may or may not be the best choice for a complete RFB system. Continuing to further understand and model how membrane transport properties are affected by different solvents and active materials would greatly inform the process of engineering membrane, solvent, and active material components. The tradeoffs in these membrane transport properties created by the component choices can be combined with tradeoffs in other aspects of RFB system design to advance overall RFB system performance.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A cross-linked blended membrane composition comprising:
a blend of a first polymer and a second polymer,
wherein the first polymer is a cross-linked polymer; and
wherein the first polymer has a structure represented by a formula: 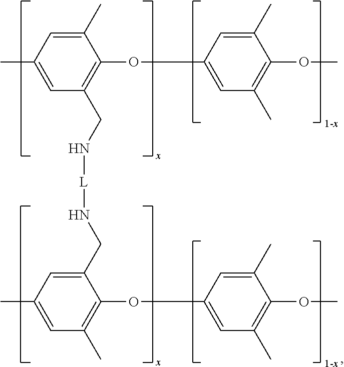
wherein x has a value from about 0.2 to about 0.9; and
wherein L is a structure represented by a formula selected from: 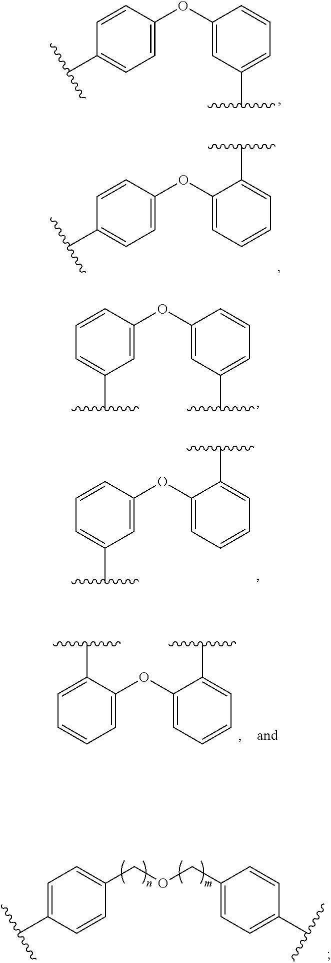
wherein each of n and m is an integer independently selected from 0, 1, 2, and 3;
wherein the second polymer has a structure represented by a formula: 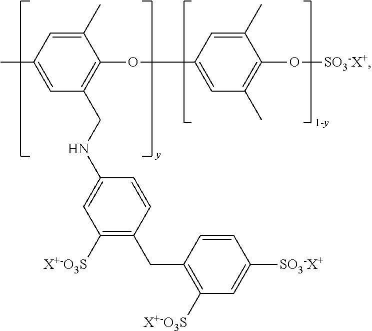
wherein y has a value from about 0.02 to about 0.6; and
wherein X⁺ is a cation selected from H⁺, an alkali metal cation, and combinations thereof.

2. The cross-linked blended membrane composition of claim 1, wherein L is a structure represented by a formula selected from:

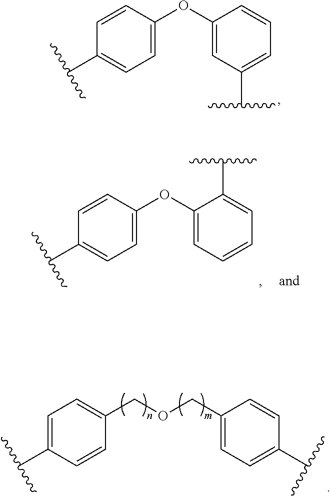

3. The cross-linked blended membrane composition of claim 2, wherein L is a structure represented by a formula:

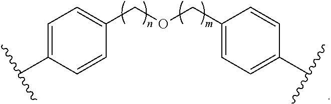

4. The cross-linked blended membrane composition claim 3, wherein each of n and m is an integer independently selected from 0, 1, and 2.

5. (canceled)

6. The cross-linked blended membrane composition claim 3, wherein each of n and m is 0; and wherein L is a structure represented by a formula:

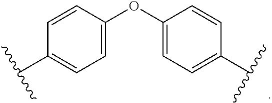 [SMILES: *c1ccc(Oc2ccc(*)cc2)cc1]

7. The cross-linked blended membrane composition claim 1, wherein X⁺ is selected from H⁺, Li⁺, Na⁺, and K⁺.

8.-11. (canceled)

12. The cross-linked blended membrane composition of claim 1, wherein y has a value from about 0.04 to about 0.4.

13. The cross-linked blended membrane composition of claim 1, wherein the first polymer is present in an amount of about 5 wt % to about 40 wt %; wherein the second polymer is present in an amount of about 95 wt % to about 60 wt %; wherein a total wt % is 100 wt %; and wherein the total wt % is based on a total weight of the first polymer and the second polymer.

14.-26. (canceled)

27. The cross-linked blended membrane composition of claim 1, wherein the cross-linked blended membrane composition has a lithium-ion conductivity of greater than or equal to about 0.05 mS cm⁻¹ where determined in accordance with the methods disclosed herein.

28.-38. (canceled)

39. A redox flow battery comprising:
comprising the cross-linked blended membrane composition claim 1;
a positive electrode;
a positive electrolyte comprising a first redox active composition, wherein the positive electrolyte is in contact with the positive electrode;
a negative electrode; and
a negative electrolyte comprising a second redox active composition, wherein the negative electrode is in contact with the negative electrode, and
wherein the cross-linked blended membrane composition is interposed between the positive electrode and the negative electrode.

40. The redox flow battery of claim 0, wherein the redox flow battery is a non-aqueous redox flow battery.

41. The redox flow battery of claim 0, wherein the positive electrode and the negative electrode independently comprise a metal, a carbon material, an electro-conductive polymer, and combinations thereof.

42. The redox flow battery of claim 0, wherein the positive electrolyte and the negative electrolyte each comprise a solvent independently selected from the group consisting of acetonitrile, dimethylacetamide, diethyl carbonate, dimethyl carbonate, γ-butyrolactone, propylene carbonate, ethylene carbonate, N-methyl-2-pyrrolidone, fluoroethylene carbonate, N,N-dimethylacetamide, and combinations thereof.

43. The redox flow battery of claim 0, wherein the positive electrolyte and the negative electrolyte each comprise the same solvent.

44. The redox flow battery of claim 0, wherein the positive electrolyte and the negative electrolyte each comprise a solvent independently selected from the group consisting of acetonitrile, dimethylacetamide, diethyl carbonate, dimethyl carbonate, and combinations thereof.

45. The redox flow battery of claim 0, wherein the solvent is dimethyl carbonate.

46. The redox flow battery of claim 0, wherein the positive electrolyte and/or the negative electrolyte comprise an electrolyte salt selected from the group consisting of lithium bis(fluorosulfonyl)imide, lithium tetrafluoroborate, lithium hexafluorophosphate, lithium perchlorate, lithium methyltrifluoromethanesulfonate, lithium bis(trifluoromethylsulfonyl)imide, tetraethyl ammonium tetrafluoroborate, tetrabutyl ammonium tetrafluoroborate, and combinations thereof.

47. The redox flow battery claim 0, wherein the first and/or second redox active compositions comprise a metallocene.

48. The redox flow battery of claim 0, wherein the metallocene is a ferrocene.

49.-51. (canceled)

52. A method for making a cross-linked blended membrane composition, the method comprising:
forming a pre-crosslinking mixture comprising a first polymer and a second polymer,
wherein the first polymer has a structure represented by a formula: 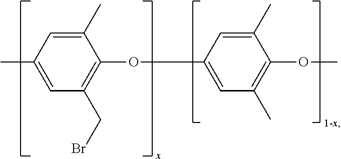
wherein x has a value from about 0.2 to about 0.9;
wherein the second polymer has a structure represented by a formula: 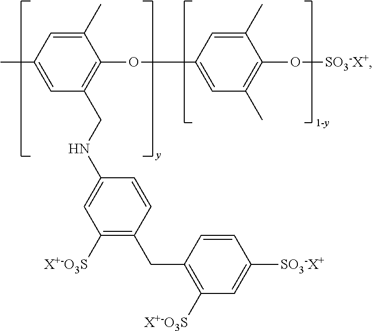
wherein y has a value from about 0.02 to about 0.6; and
wherein X⁺ is a cation selected from H⁺, an alkali metal cation, and combinations thereof;
forming a pre-crosslinked membrane from the pre-crosslinking mixture;
drying the uncrosslinked membrane;
pre-swelling the pre-crosslinked membrane with a swelling solution comprising a cross-linker and a first organic solvent, thereby forming a swollen pre-crosslinked membrane; and
wherein the cross-linker is a structure represented by a formula selected from: 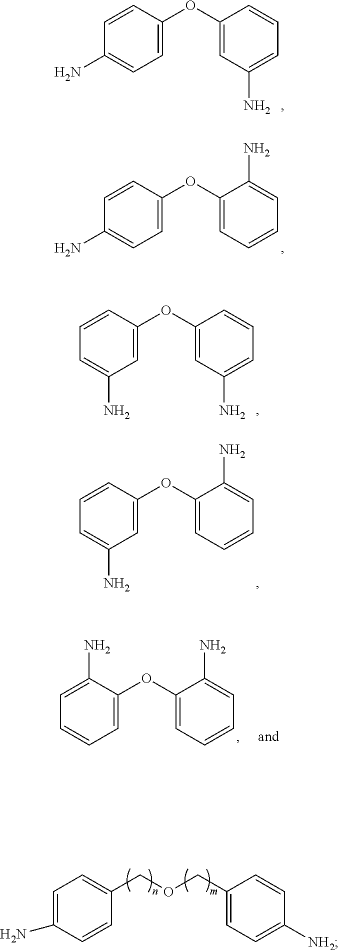
wherein each of n and m is an integer independently selected from 0, 1, 2, and 3;
initiating a cross-linking reaction in the swollen pre-crosslinked membrane by adding an initiator in a second organic solvent thereto, thereby forming the cross-linked blended membrane composition;
wherein the cross-linked blended membrane composition comprises the second polymer and a cross-linked polymer formed from reaction of the crosslinker;
wherein the cross-linked polymer has a structure represented by a formula: 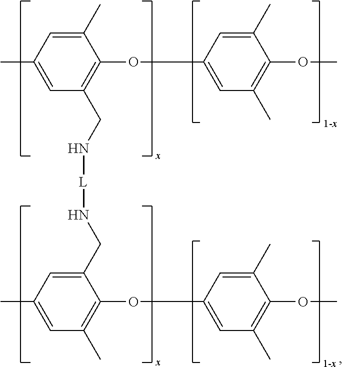
wherein L is a structure represented by a formula selected from:

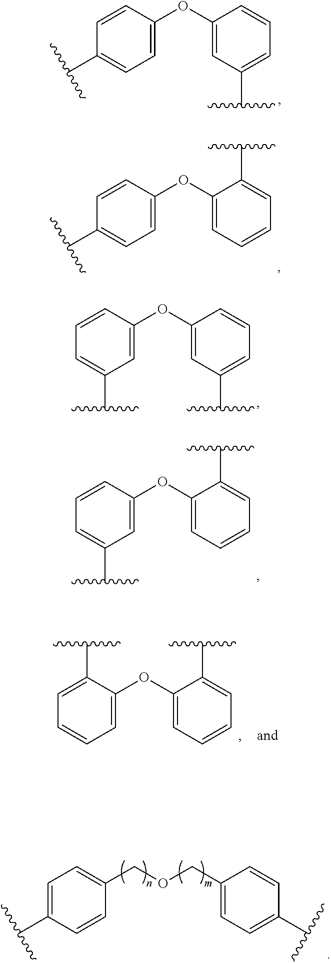

53.-93. (canceled)
